(19) United States
(12) Patent Application Publication
(10) Pub. No.: US 2005/0008990 A1
(43) Pub. Date: Jan. 13, 2005

(54) Method and system for repairing endosseous implants, such as with a bone graft implant

(75) Inventors: Scott D. Ganz, River Vale, NJ (US); Peter A. Materna, Metuchen, NJ (US); Roger C. Stikeleather, Doylestown, PA (US); Thomas J. Bradbury, Yardley, PA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Therics, Inc., Princeton, NJ (US)

(21) Appl. No.: 10/789,439

(22) Filed: Feb. 26, 2004

Related U.S. Application Data
(60) Provisional application No. 60/450,411, filed on Feb. 26, 2003.

(51) Int. Cl. A61C 5/00; A61C 8/00

(52) U.S. Cl. 433/215; 433/173

(57) ABSTRACT

A bone graft that is made at least partially of synthetic material and is of a suitable shape to fill a recess around the base of an ailing/failing endosseous implant. The bone graft may be pre-manufactured in the suitable shape. The invention also comprises a method of installing either such a bone graft or any other type of filler. The invention also comprises various types of bone graft profiler tools suitable for preparing the recess, and optionally an alignment post to assist in the use of the bone graft profiler tool(s). The dimensions of the bone graft profiler tool(s) and the dimensions of the bone graft and the dimensions of the alignment post may be chosen to have defined geometric relationships with respect to each other, with respect to the dimensions of the existing implant base, and with respect to the extent of bone deterioration at a particular implant site in a particular patient.

### BACKGROUND OF THE INVENTION

1. Field of the Invention

The present invention relates to a method and system for repairing endosseous implants, and more particularly, to a bone graft for such repair, method of manufacturing the bone graft, a bone graft profiler tool, an alignment post and a system for installing the same.

2. Description of the Related Art

An endosseous implant (EDI) comprises an implant base that is installed directly into the bone of a patient's mandible or maxilla, an abutment post that engages the implant base, and a tooth prosthesis that attaches onto the abutment post. Basic techniques of implant dentistry are described in “An Illustrated Guide to Understanding Dental Implants,” by Scott D. Ganz, D.M.D. (1993). Implant dentistry has become a practical restorative method with a high reliability and success rate. However, in a small fraction of cases, an endosseous implant has been observed to loosen with the passage of time, due to deterioration or resorption of bone immediately adjacent to the implant base. The success of an EDI requires that the implant base always have a sufficient length that is supported by intimate contact with bone. Loss of support from some portion of the adjacent bone can lead to loosening and mechanical failure of an originally secure EDI.

FIG. 2A illustrates a first implant with a healthy amount of bone, and a second implant 200 having bone loss 215 or deterioration around the implant. FIG. 2B shows two X-rays illustrating two examples of crestal bone loss, which destroys the buccal and lingual cortical plates of bone. The X-rays in FIG. 2B show the bone adjacent to the endosseous implants deteriorated or missing, leaving the EDI with inadequate mechanical support. In both of these X-rays, the implant base had originally been installed in such a way that there was bone all the way to the indicated line. Over time, the bone receded to the boundary as indicated by the arrows and the overdrawn curved lines.

The most common treatment for an ailing/failing EDI has been to leave the implant base in place, expose the region of deteriorated/resorbed bone and cut away deteriorated bone or other tissue adjacent to the implant base. The recess thus created was then filled with a filler. In many cases the filler has been a formable filler material that has comprised demineralized bone matrix, bone chips, a putty comprising components derived from bone, etc., i.e., a filler that has not been pre-formed or rigid. The success rate of this procedure has been erratic and low. The formable filler material has sometimes migrated over a period of time after surgery. In some cases the formable filler material has become well integrated with existing bone, but in other cases it has not. In still other cases, the filler material has become integrated with bone but has later resorbed, resulting in a re-occurrence of the original problem.

In some cases a similar repair procedure has been done using a filler that has been harvested bone (either allograft or autograft), which has been shaped. Because the autograft or allograft has been solid, such a procedure has avoided the migration problem experienced with formable material, but the bone installed in such a procedure has still been subject to possible resorption, which would represent a re-occurrence of the original problem. As is usually the case with such sources of bone material, the use of allograft bone has introduced the possibility of disease transmission from the donor, and the use of an autograft has involved the extra inconvenience, pain and expense of the surgery at a second site in the same patient for harvesting of bone.

In regard to surgical technique, preparation of the recess around the sides of the implant base has typically been performed using localized cutting tools such as small burrs. This yields inconsistent preparation of the recess due to the difficulty accessing portions between the implant base and existing teeth. Typically a significant portion of the cutting and fitting has been decided upon as the surgery progressed.

In general, there remain multiple needs for better methods of repairing bone around an ailing/failing endosseous implant. It would be desirable to avoid the problems of migration of non-solid material. It would be desirable to avoid the problems of second site surgery or possible disease transmission that are inherent with autograft and allograft, respectively. For any implanted material, it would be desirable to avoid resorption of the implanted material. It would be desirable to make the surgical process as efficient as possible by reducing the amount of unrehearsed cutting and fitting which has to take place during surgery, and also to improve the fit between any bone graft and the prepared recess into which the bone graft is placed.

### BRIEF SUMMARY OF THE INVENTION

The present invention comprises a bone graft which is made at least partially of synthetic material and which may be of a suitable shape, and in some cases may be pre-manufactured in the suitable shape, to fill a recess around the implant base of an ailing/failing endosseous implant. The invention also comprises a method of installing either such a bone graft or any other type of filler. The invention also comprises various types of bone graft profiler tools suitable for preparing the recess, and optionally an alignment post to assist in the use of the bone graft profiler tool(s). The dimensions of the bone graft profiler tool(s) and the dimensions of the bone graft and the dimensions of the alignment post (if used) may be chosen to have defined geometric relationships with each other and with the dimensions of the existing implant base and the extent of bone deterioration at a particular site in a particular patient. The invention also comprises a combination of at least one bone graft, at least one bone graft profiler tool, and optionally an alignment post and possibly other surgical articles combined into an appropriate kit.

### BRIEF DESCRIPTION OF THE DRAWINGS

The present invention is further illustrated in the following Figures, in which:

FIG. 1 illustrates a three-dimensional printing apparatus in accordance with the prior art.

FIGS. 2A and 2B show a schematic and an X-ray, respectively, illustrating implants in good condition and implants requiring repair in accordance with principles of the present invention.

FIG. 3 illustrates the first step in a repair procedure of the present invention, which is removal of the tooth prosthesis and the abutment post from the implant-base in accordance with principles of the present invention.

FIG. 4 illustrates the use of alignment post that interacts with the bone graft profiler tool to help locate and/or align the bone graft profiler tool for creating or enlarging the recess in accordance with principles of the present invention.

FIG. 5 illustrates a schematic cross section of a further step in a repair procedure of the present invention, in which after a profiled recess has been created, a bone graft of the present invention is about to be installed in the recess in accordance with principles of the present invention.

FIG. 6 illustrates an exploded view of FIG. 5.

FIG. 7 illustrates a similar step as FIG. 6, in which the recess prepared by the method of the present invention is about to be filled by a formable material in accordance with principles of the present invention.

FIG. 8 illustrates the surgical site with the bone graft installed in accordance with principles of the present invention.

FIG. 9 illustrates installation or re-installation of the abutment post and the tooth prosthesis in accordance with principles of the present invention.

FIG. 10 illustrates suturing of the gingival in accordance with principles of the present invention.

FIG. 11 illustrates an alignment post of the present invention in accordance with principles of the present invention.

FIG. 12 illustrates a bone graft profiler tool interacting with an alignment post illustrating mis-location in accordance with principles of the present invention.

FIG. 13 illustrates a bone graft profiler tool interacting with an alignment post illustrating mis-orientation in accordance with principles of the present invention.

FIG. 14 and FIGS. 15A-E illustrate various configurations of the internal profiler tool recess and the distal region of the alignment post in accordance with principles of the present invention.

FIGS. 16 and 17A-D illustrate various steps in the motion of a bone graft profiler tool towards an implant base, wherein both the alignment post and the bone graft profiler tools comprise chamfers to assist in locating in accordance with principles of the present invention.

FIG. 18 shows a bone graft profiler tool whose exterior comprises a mark in the form of a groove to indicate dimensional information in accordance with principles of the present invention.

FIGS. 19A and 19B illustrates bone graft profiler tools whose cutting region comprises interrupted cutting surfaces with individual blades in accordance with principles of the present invention.

FIG. 20 is a photograph of a bone graft of the present invention.

FIG. 21 illustrates a carrier suitable for transporting the bone graft to the surgical site in accordance with principles of the present invention.

### DETAILED DESCRIPTION OF THE INVENTION

Method of Installing a Bone Graft or Other Filler Using a Bone Graft Profiler Tool

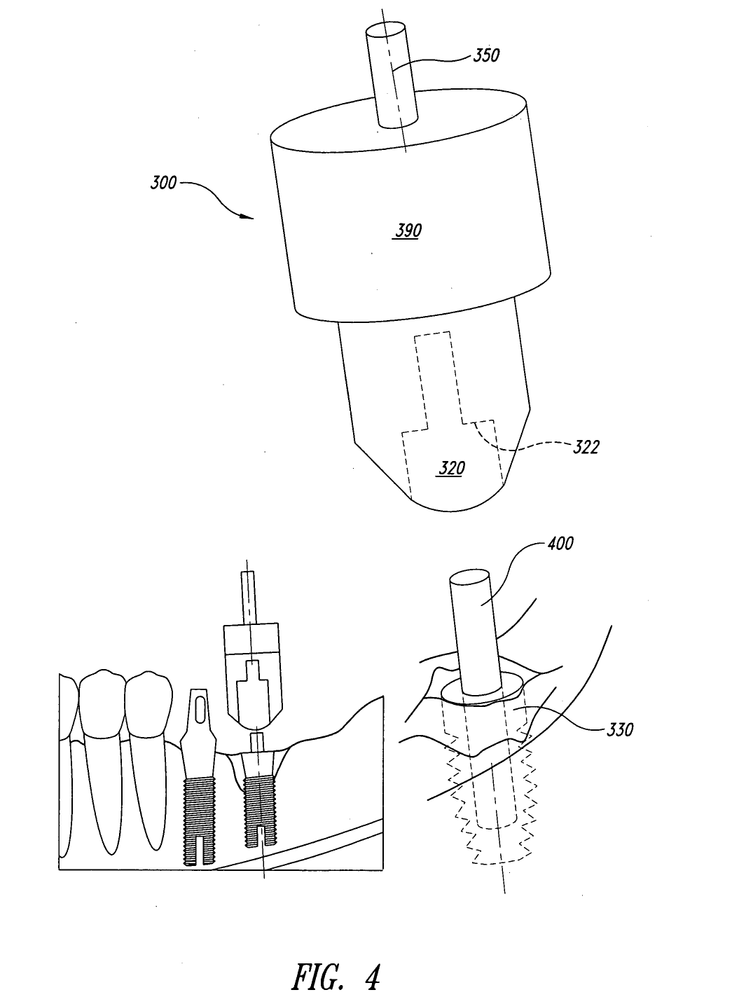

One aspect of the present invention is a method of repairing an ailing/failing endosseous implant using a bone graft profiler tool. The method of repair is illustrated in FIGS. 3 through 11. As illustrated in FIG. 4, an endosseous implant 300 already installed in a patient may comprise an existing implant base 330 which is already installed in the patient's maxilla or mandible, and an abutment post 310 which engages securely with the implant base 330, and a tooth prosthesis 320 which attaches to the abutment post 310. The tooth prosthesis 320 may be either a single tooth (as illustrated) or a part of a larger prosthesis structure, such as a bridge, which may be supported either by one abutment post. (as illustrated) or by more than one abutment post.

The first step of the method of the present invention may be to remove the existing tooth prosthesis 320 from the abutment post 310 and to remove the abutment post 310 from the implant base 330. The tooth prosthesis 320 and the abutment post 310 are removed from the existing implant base 330, and the existing implant base 330 is then visible in the midst of the gingiva. Typically, as part of planning the surgical procedure of the present invention, the dimensions of the existing implant base 330 would be known from records.

As shown in FIG. 4, tissue adjacent to the implant base 330 may be further exposed by resecting appropriate gingiva so as to expose a larger region, which may include deteriorated bone, ordinary bone, and other tissue, all of which may collectively be referred to as tissue

The next step may be to insert into the existing implant base 330 an alignment post 400 as shown in FIG. 4, although this step is optional. The use of an alignment post may be of interest because the angular orientation of an implant base 330 may not be especially apparent based on what is visible at this point in the surgical procedure, and indeed the orientation of the implant base 330 may have been chosen based on the expected direction of adequately thick bone in the jaw, rather than on the intended orientation of teeth. With the abutment post 310 having been removed from the implant base 330, some implant base geometric features that formerly engaged the abutment post 310 are accessible and can be used to provide information about the location and orientation of the implant base 330. Such information can be valuable for later steps of preparation of the surgical site.

In a typical implant base 330, many features of the implant base 330 have axisymmetry and coaxiality around an axis 350 of symmetry of the implant base 330, and one such coaxial feature would be the aperture or hole 340, which may be threaded, which accepts the abutment post 310. It can be noted that the threads themselves, being helical, could not strictly be described as axisymmetric, but the hole 340 still can have an axis that can be coaxial with the overall axis 350 of the implant base 330. Typically it may be desired that the profiled recess that is prepared using the bone graft profiler tool of the present invention should be at least approximately coaxial with axis 350 of the implant base 330. It is possible to obtain the location and orientation of the axis 350 of the implant base 330 by inserting into the threaded hole 340 in the implant base 330 an alignment post 400 which has an axis which substantially coincides with the axis 350 of implant base 330, with the alignment post 400 extending out beyond implant base 330 and providing reference surfaces which indicate the location and orientation of the axis 350 of the implant base 330. Such reference surfaces on the alignment post 400 may later cooperate with a bone graft profiler tool 300 to help determine the location and/or orientation of the bone graft profiler tool 300. The alignment post 400 is an aspect of the present invention and is further described elsewhere herein. Locating and/or orienting the bone graft profiler tool 300 without the use of an alignment post are also possible and are described elsewhere herein.

The next step may be the cutting away of tissue near the existing implant base 330 in order to prepare a recess. The desired recess may be either a profiled recess that is substantially axisymmetric or a custom-shaped recess that has some other shape. Preparation of a profiled recess around the top of the implant base may be performed using a bone graft profiler tool of the present invention.

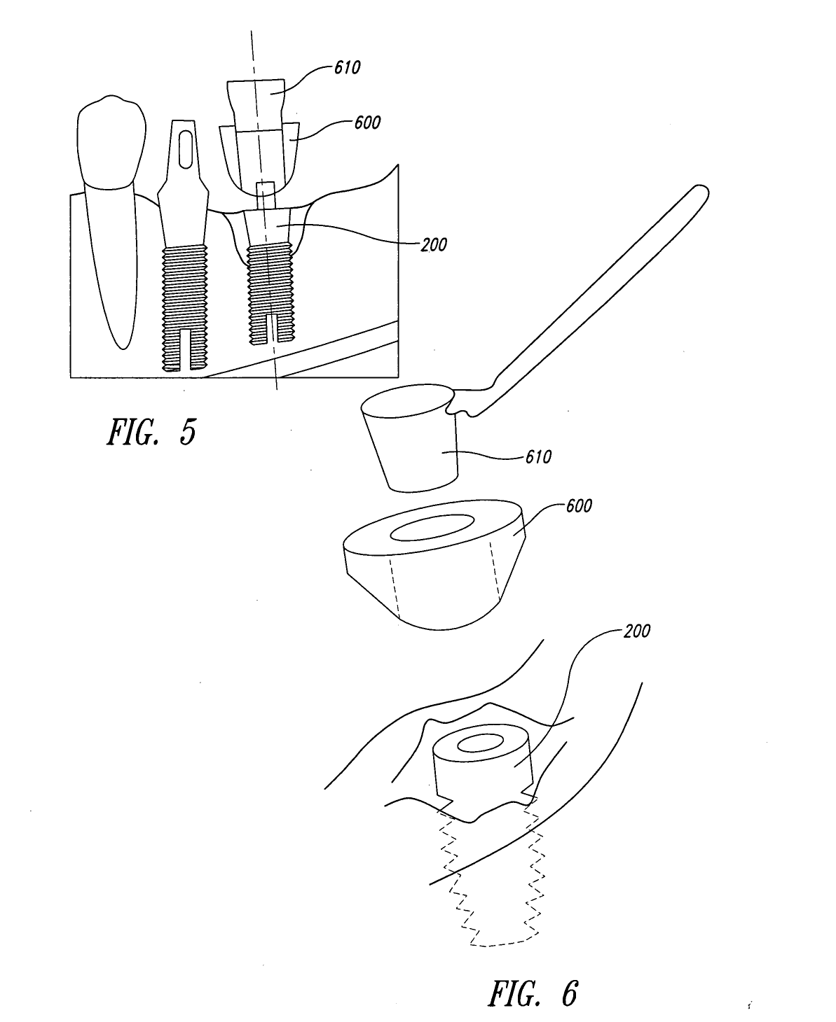

FIG. 4 shows that an appropriate bone graft profiler tool 300 may be brought in to cut away tissue (such as deteriorated bone, bone, etc.) near the implant base 330, and/or to re-size or re-shape any recess in the tissue which may already exist adjacent to the implant base 330, thereby creating a profiled recess. The bone graft profiler tool 300 may be generally axisymmetric, having an axis of symmetry 350, and being rotatable around its axis of symmetry 350. The bone graft profiler tool shown in FIG. 4 is suitable to cooperate with alignment post 400. The bone graft profiler tool 300 is also an aspect of the present invention and is described elsewhere herein. During use, the bone graft profiler tool 300 may be driven by an appropriate rotary drive 390 (only partially shown in FIGS. 4 and 5). The bone graft profiler tool 300 may be operated until an intended amount of tissue such as deteriorated bone has been removed and the profiled recess has attained the desired shape and dimensions. Control of the depth of cut may be attained as described elsewhere herein.

This discussion has, for simplicity, referred to a bone graft profiler tool as a single tool. However, it is possible that the surgical procedure may involve using a sequence of bone graft profiler tools, with each respective bone graft profiler tool removing bone beyond what was cut away by the tool used immediately preceding it. In particular, the last bone graft profiler tool in the sequence may be designed to remove a specified amount of bone beyond what was removed by the immediately preceding bone graft profiler tool, because sometimes, as a function of the material being cut, there is an optimum amount of material removed in a given cut to achieve optimum quality of cut or dimensional accuracy. In a given sequence of bone graft profiler tools, successive tools may have a deeper depth of cut, or may have fuller dimensions in the dimension perpendicular to the axis, or both.

Dimensions of the bone graft profiler tool(s) 300 may be chosen with relation to the existing implant base 330, the dimensions of the alignment post 400 (if an alignment post is used), the dimensions of deteriorated bone at a particular site in a particular patient, the dimensions of the intended bone graft 600, and any other relevant dimensions. These choices may be made based, at least in part, on radiographic data about the intended surgical site in the patient. The bone graft profiler tool(s) 300 may be chosen in advance of surgery.

Alternatively, it is also possible to perform the cutting away using a bone graft profiler tool without the use of an alignment post. If no alignment post is used, the implant base 330 itself may somewhat serve to at least locate and possibly orient the bone graft profiler tool 300. A bone graft profiler tool designed for use without an alignment post need not comprise an alignment post internal recess, but otherwise may resemble the bone graft profiler tool 300 already described. Thus, a bone graft profiler tool for use without an alignment post may be slightly simpler or more compact. However, in a procedure without an alignment post it might be more difficult to achieve proper locating and/or orienting of the bone graft profiler tool, and there is more possibility of the bone graft profiler tool contacting the implant base. Individual surgical situations and surgeon preferences may influence whether to use an alignment post.

The surgical site preparation using the bone graft profiler tool 300 as illustrated in FIG. 4 resulted in a profiled recess that is axisymmetric because of having been created by a rotating tool. However, it is possible that for a given site in a given patient, the shape of the region of deteriorated/resorbed bone near the implant base 330 may be non-axisymmetric, and for this reason (or for any other reason) the desired shape of the recess may be non-axisymmetric. In this situation it is possible to prepare a profiled recess as just described and then to modify that profiled recess in local places using a localized tool such as a small burr to achieve a custom-shaped recess (not shown). This might be done, for example, if the desired shape of the recess is only slightly non-axisymmetric.

Possible preparation of a recess entirely by using a localized tool is also possible and is described elsewhere herein.

It is possible that during surgery, modifications may be made to improve the fit between the profiled recess and the bone graft 600, by removing material from either the bone graft 600 or the bone at the surgical site or both. Such material removal may be made with any known tools, burrs or other cutting or scraping tools, which may be either powered or hand-held.

After completion of preparation of the recess (either a profiled recess or a custom-shaped recess), it is possible to apply an antiseptic such as citric acid to the surgical site, such as in the case where bone deterioration occurred as a result of infection. It is similarly possible that an antibiotic or similar substance could be applied at this point. Such substances may be in liquid or semi-solid form.

FIGS. 5 and 6 illustrate the appearance of the surgical site after the cutting of the bone has been performed using the bone graft profiler tool 300 and shows that a recess adjacent to the implant base 330 has been created having the desired configuration; the figures further show a bone graft 600 near the recess ready to be installed in the recess.

After the recess adjacent to the implant base 330 has been created as just described, the recess may be filled with a filler. One option is that the filler may be a rigid or semi-rigid bone graft 600 which may be placed into the profiled recess. A bone graft 600 of the present invention may be made at least partly of synthetic material, and is described elsewhere herein. A bone graft of the present invention could also be made of demineralized bone matrix as a matrix material, as described elsewhere herein. It would also be possible to install a similarly shaped natural bone graft made of allograft or autograft or xenograft material.

FIGS. 5 and 6 show such a bone graft 600 about to be placed into position in the recess. Such a bone graft would have its shape prior to being placed in the recess for final installation. The bone graft 600 might have its final shape prior to surgery, or it might have an approximate shape prior to surgery with modifications being made during surgery, or it might simply be a non-specific shape such as a block that is entirely shaped during surgery. Placing the bone graft 600 into position may be facilitated by the use of a carrier 610 which grips or attaches to the bone graft 600 in a way which does not interfere with motion of the bone graft 600 into the desired position and does not damage the bone graft. The carrier 610 is also an aspect of the present invention and is described elsewhere herein.

It is possible that the design of the recess and the design of the bone graft 600 maybe such that when the bone graft 600 is installed in the recess, the bone graft 600 is maintained in sufficient contact with adjacent natural bone simply by virtue of its shape and dimensions, due to friction, slight dimensional interference, etc. For example, this might be the case if the bone graft 600 is frusto-conical with the apex angle of the cone being quite shallow, with the recess being of similar shape. However, in other cases it may be that the bone graft 600 requires some anchoring in order to maintain it in contact with the adjacent bone. If such anchoring is needed, appropriate procedures may be performed at this time during the surgical procedure, such as to maintain the bone graft in contact with natural bone. For example, surgical screws (not shown) or other appropriate fasteners may be used, and in order to accommodate such fasteners appropriate features such as holes (not shown) either may be provided in the bone graft 600 at the time of its manufacture or may be drilled during surgery.

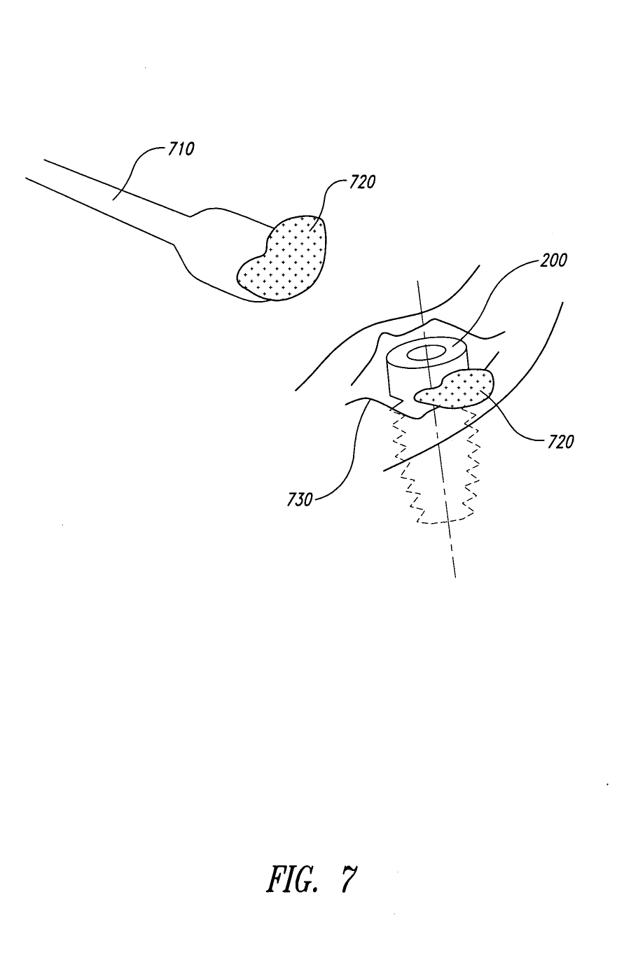

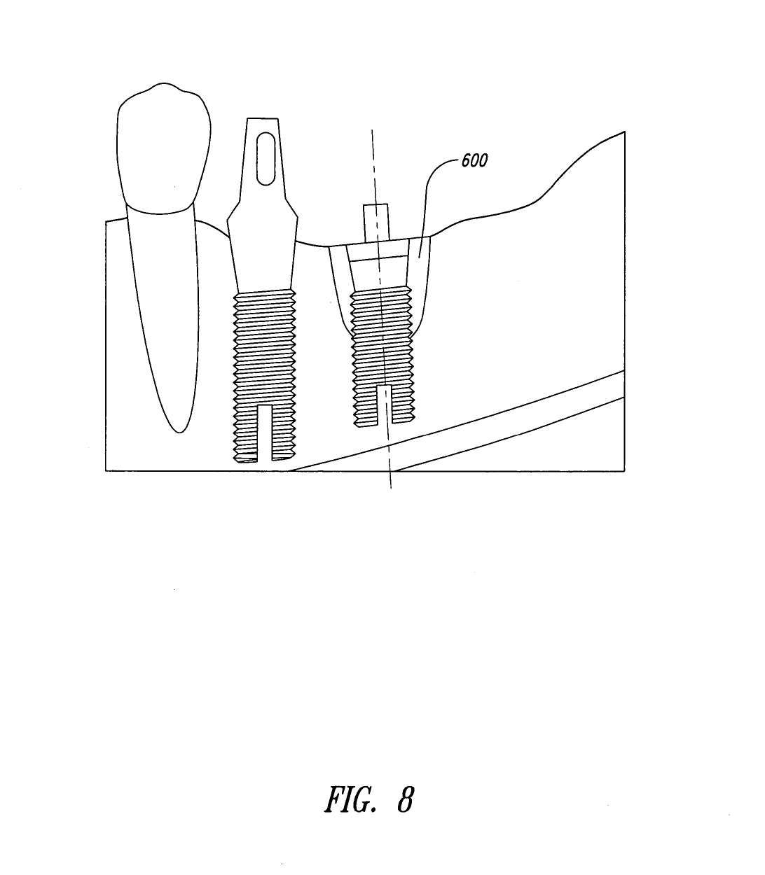

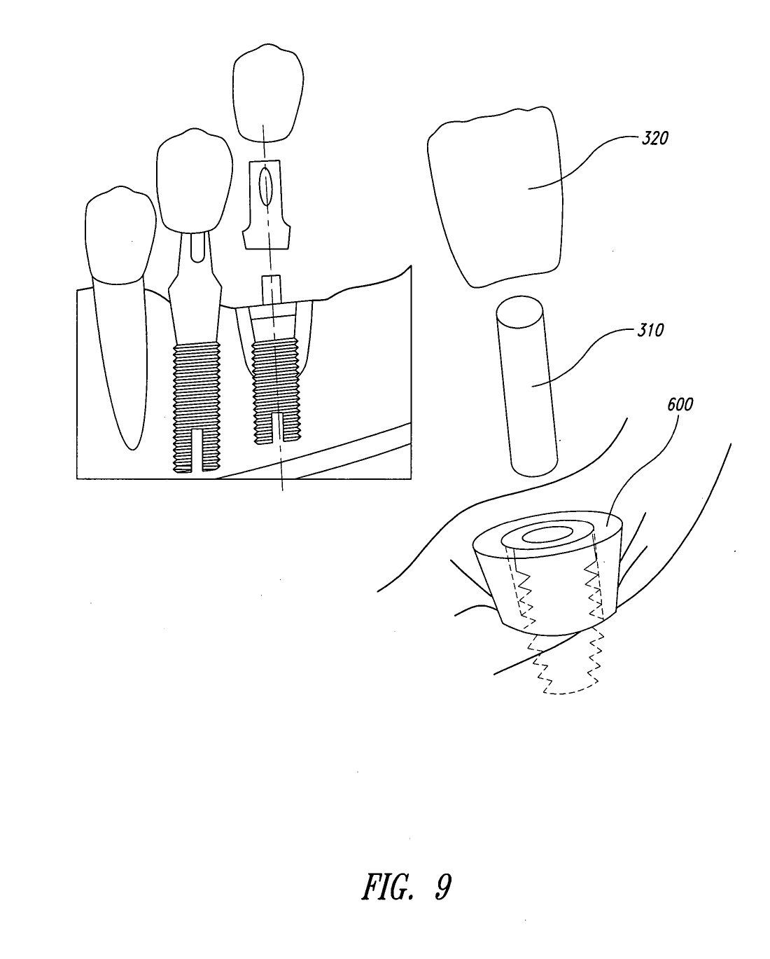

As an alternative, it is possible that, as a filler, a formable material 720 may be installed into the profiled recess 730 as is shown in FIG. 7. FIG. 7 shows a formable material 720 being brought into place on an applicator 710, with some formable material 720 already being in place. Installing a formable material 720 in the profiled recess 730 could be done as in current practice but the procedure could still include the novel step of preparing the profiled recess 730 using the bone graft profiler tool 300 described herein.

In the later stages of surgery, various surgical substances in liquid or semi-solid form may be applied as desired. For example, in the case of a bone graft 600 comprising a rigid material (as opposed to filling the recess entirely with formable material), it is possible to use formable material to fill in possible gaps between the bone graft 600 and the recess, or any other similar gaps, either after or before final installation of the bone graft 600 in the recess. As already mentioned, antiseptics and/or antibiotics may be applied, such as in cases where bone deterioration occurred as a result of infection.

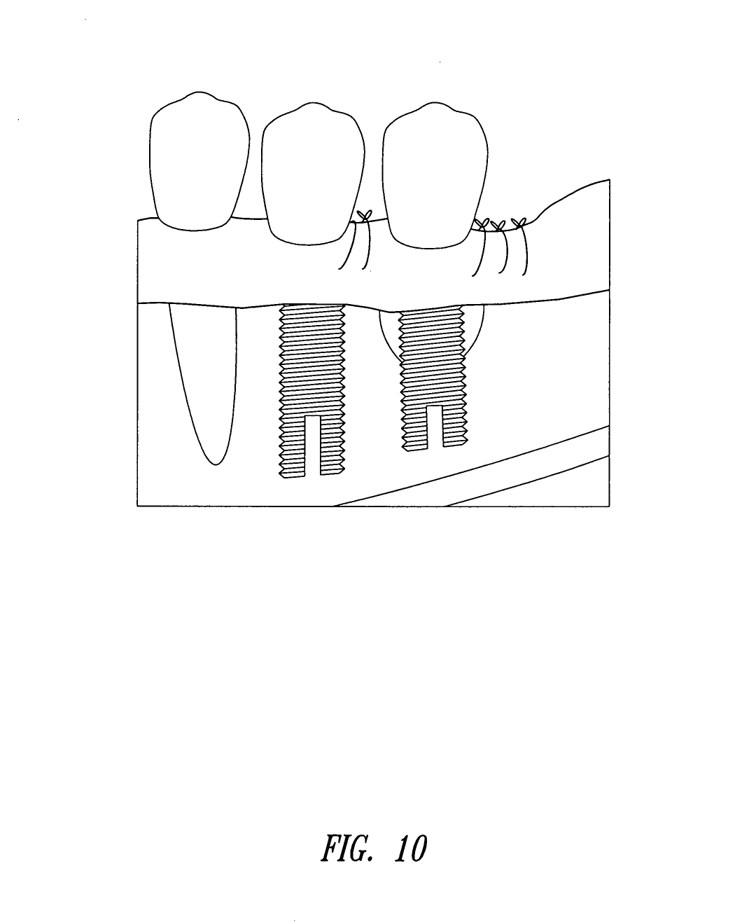

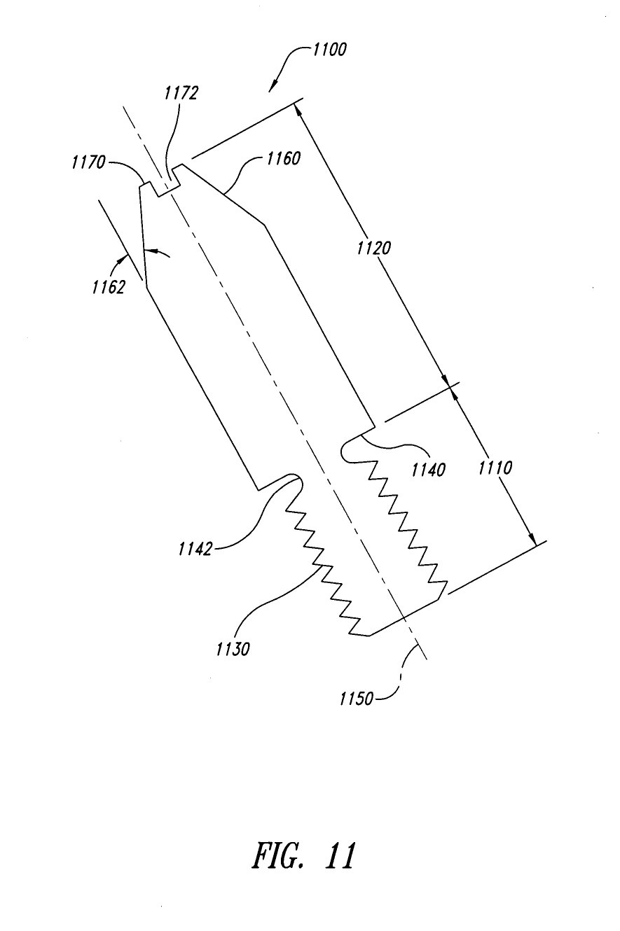

FIG. 8 illustrates a bone graft 600 already placed in its final position in the recess. At this stage, if desired, a surgical membrane (not shown), made of materials such as Gore-Tex or collagen, may be applied to restrict the growth of soft tissue in certain places such as between the bone graft 600 and the gingiva. Then, as shown in FIG. 9, an abutment post 310, which may be the same abutment post removed earlier in the surgery, may be installed, and a tooth prosthesis 320, which may be the same tooth prosthesis removed earlier in the surgery, may be installed. The gingiva may then be closed up and sutured, as illustrated in FIG. 10. The gingiva may be closed to approximately their contours just prior to the surgery.

Method of Installing Bone Graft Without Using a Bone Graft Profiler Tool

It is also possible to install a bone graft 600 of the present invention, which is described elsewhere herein, even if the bone graft profiler tool 300 of the present invention is not used to prepare the surgical site. In this case, the overall surgical procedure would be similar to the procedure just described, except that cutting could be performed by something other than the bone graft profiler tool 300. For example, cutting could be performed using small burrs that cut only a localized region at one angular location with respect to the implant base, in what could be described as a hand operation. In such a procedure, the contours of the recess may be determined visually or by trial fitting during the surgery. The bone graft 600 of the present invention, which is made of a rigid material, could then be installed. Preparatory steps and follow-up steps could be as already described.

Alignment Post

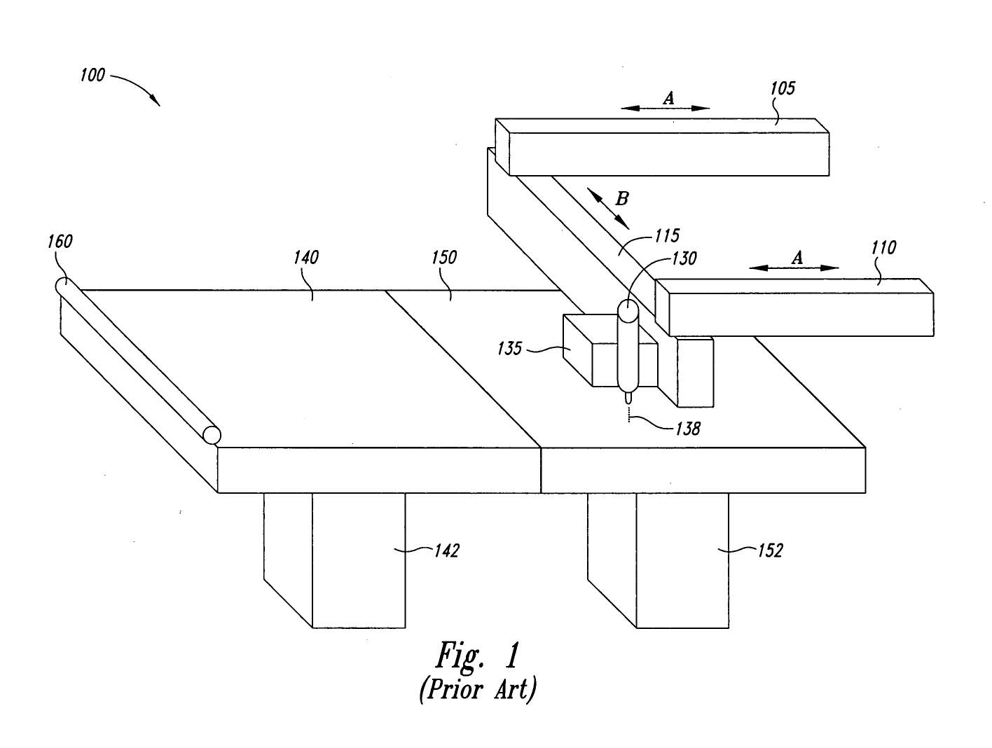

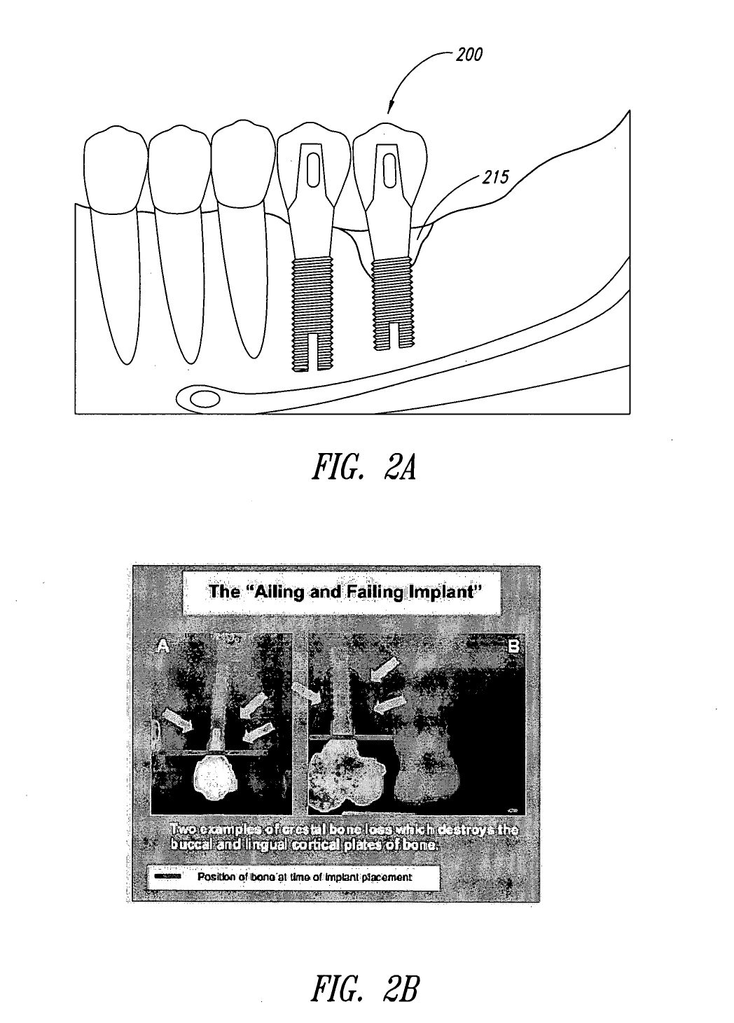

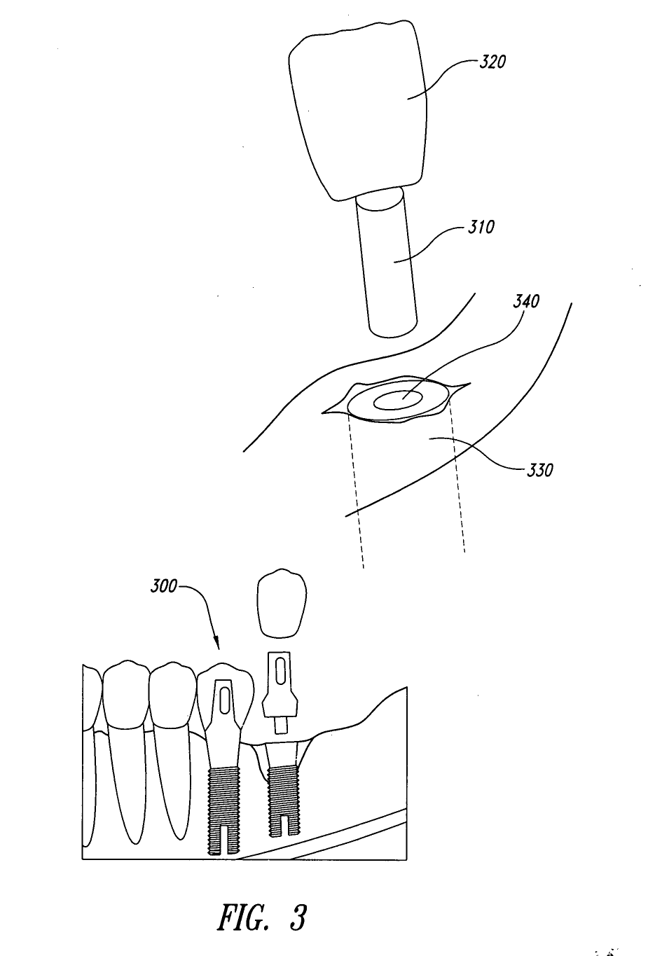

Another aspect of the present invention is an alignment post. An alignment post can optionally be used in the practice of the present invention, although it does not have to be used, even if a bone graft profiler tool is used. A suitable alignment post 1100 is shown in FIG. 1 1. Alignment post 1 100 may be axisymmetric, except for certain details as noted, around an axis of symmetry 1150 and may be designed so that when alignment post 1100 is engaged with implant base 330, alignment post axis 1150 substantially coincides with axis 1150 of implant base 330. The alignment post 1100 may comprise an engagement region 1110 and a distal region 1120, with the engagement region 1110 and the distal region 1120 being connected to each other or integral with each other, and With the engagement region 1110 and the distal region 1120 being (except for possible helical threads and possibly a gripping feature) axisymmetric around an axis 1150 and coaxial with each other. The overall length of the alignment post 1100 may be such that when the alignment post 1100 is installed in the implant base 330, the distal region 1120 extends beyond the implant base 330.

In such an alignment post, the engagement region 1110 may comprise engagement features 1130 which are suitable to engage with the corresponding features in the hole 1140 in the implant base 330. The engagement features 1130 of engagement region 1110 may be similar to the corresponding features on the abutment post 1110. For example, it may be that the abutment post 1110 was threaded into threads in a threaded hole 1140 in the implant base 330, and the engagement region 1110 of alignment post 1100 may contain similar threads 1130 to engage the threads in the threaded hole 1140 in the implant base 330. The engagement feature may be designed so as to result in the axis 1150 of alignment post being substantially coaxial with the axis 1150 of implant base 330.

The distal region 1120 of the alignment post 1100 may extend out past the implant base 330 when the alignment post 1100 is installed in the implant base 330. The distal region 1120 of alignment post 1100 may comprise features suitable to cooperate with the bone graft profiler tool 1100 to locate and/or orient the bone graft profiler tool 1100 with respect to the implant base 330. Specifically, the distal region 1120 may, for at least a portion of its length, be cylindrical, having an outside diameter. One possibility is that the outside diameter of the cylindrical portion of the distal region 1120 may substantially equal the outside diameter of the implant base 330. This might result in certain simplifications of the design of the bone graft profiler tool 1100. However, alternatively there may also be reasons why it would be useful for the outside diameter of the cylindrical portion of the distal region 1120 to have some lesser value. The outside diameter of the cylindrical portion of the distal region 1120 may be chosen to have a defined relationship with a corresponding alignment post internal recess inside diameter of the bone graft profiler tool 1100.

At the extreme distal end of distal region 1120 of the alignment post 1100, there may be a transition. The transition may be in general any suitable axisymmetric curve or shape. Specifically, the transition may be a chamfer 1160 as illustrated in FIG. 11, which would result in that portion of the alignment post 1100 being frusto-conical or possibly even conical. The chamfer 1160 may have a chamfer angle 1162 as illustrated which may be less than or approximately equal to 45 degrees, for example, 15 degrees or 30 degrees, as illustrated herein, although this is not critical. This transition such as chamfer 1160 may be dimensioned suitably to help the bone graft profiler tool 300 find its proper location without a large amount of searching, even if an initial guess as to its location is somewhat inaccurate.

It can be appreciated that the closer the bone graft profiler tool 300 approaches the surgical site, the more the bone graft profiler tool 300 and its associated rotary drive 390 block the view of much of the implant base 330, especially if the bone graft profiler tool 300 is everywhere continuous around its entire circumference as illustrated in FIG. 4. This visual blockage could create some difficulty in attaining the proper location and/or orientation of the bone graft profiler tool 300 with respect to the implant base 330. The alignment post 1100 in general helps to alleviate this problem, and in particular the transition such as chamfer 1160 allows increased leeway as far as being able to find the desired location and/or orientation of the bone graft profiler tool 300 even if the bone graft profiler tool 300 is brought into place from an initial location and/or orientation which are incorrectly guessed by some amount.

The distal region 1120 of the alignment post 1100 may comprise a flat 1170 on its extreme distal end regardless of whether or not a transition such as chamfer 1160 is used. The flat 1170 may serve as a stop that cooperates with an appropriate feature of the bone graft profiler tool 300 to limit the extent to which the bone graft profiler tool 300 can approach the implant base 330. However, there are also other possible ways of achieving such a stop.

The alignment post 1100 may comprise at least one alignment post gripping feature 1172 suitable for an alignment post installation tool (not shown) to engage the alignment post for purposes of tightening it, untightening it, etc. Such an alignment post-gripping feature may for example be a hexagonal recess suitable to be engaged by an Allen (hexagonal) key, or a spline recess suitable to be engaged by a spline (Torx) key. The alignment post-gripping feature 1172 may be at the extreme distal end of the distal region of the alignment post 1100 in the flat 1170 and may be located on the axis 1150 of the alignment post 1100. Alternatively, the alignment post-gripping feature could comprise a protrusion, such as a hexagonal or spline protrusion, suitable to be gripped by a corresponding tool. Alternatively, flats for gripping (not shown) may be provided at an appropriate place on the alignment post 1100.

The alignment post may comprise a shoulder 1140 where the engagement region 1110 and the distal region 1120 of the alignment post 1100 join each other. The engagement region 1110 may be dimensioned such that the shoulder 1140 bears against the implant base 330 when the alignment post 1100 is engaged to a predetermined extent into the implant base 330. Such a shoulder 1140 may be useful for precisely determining dimensions along the axis 1150 of the alignment post 1100. The portion of the engagement region 1110 closest to the shoulder 1140 may comprise a sharp internal corner or may even comprise a slight undercut 1142 as shown in FIG. 11, suitable to avoid mechanical interference with the corresponding corner of implant base 330. It is possible that the shoulder 1140 may be formed by the outside diameter of the distal region 1120 being greater than the outside diameter of the engagement region 1110, for which purpose the outside diameter of the engagement region 1110 may be considered to be the major diameter of the threads 1130, i.e., the diameter which envelopes the outermost peaks of the threads 1130 on the engagement region 1110. It is not absolutely necessary for the alignment post to have any shoulder at all.

If no shoulder is present, it would be possible that the axial position of the alignment post 1100 when installed in the implant base 330 might simply be determined by how far the alignment post 1100 can be screwed or otherwise inserted into the implant base 330, as determined perhaps by the details of the threads which are tapped inside the implant base 330. Use of a shoulder-less alignment post (which is not shown) might lessen the accuracy of dimensional information along the direction of axis 1150, but depending on the intended surgical procedure, it might not be essential to pre-determine dimensions in that direction.

The alignment post 1100 may be made of biocompatible or corrosion-resistant material and may be sterile and packaged suitably to maintain its sterility. The alignment post 1100 may be made of a ferromagnetic material to assist in its handling. The alignment post 1100 may be made of stainless steel.

Bone Graft Profiler Tool

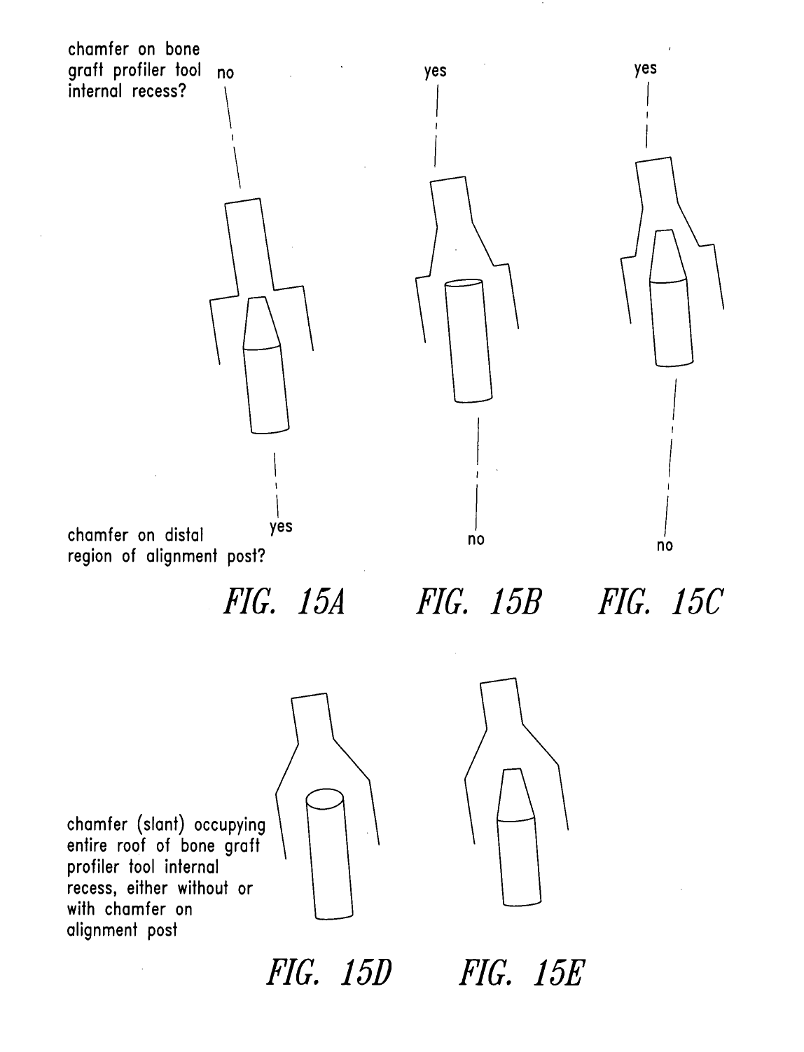

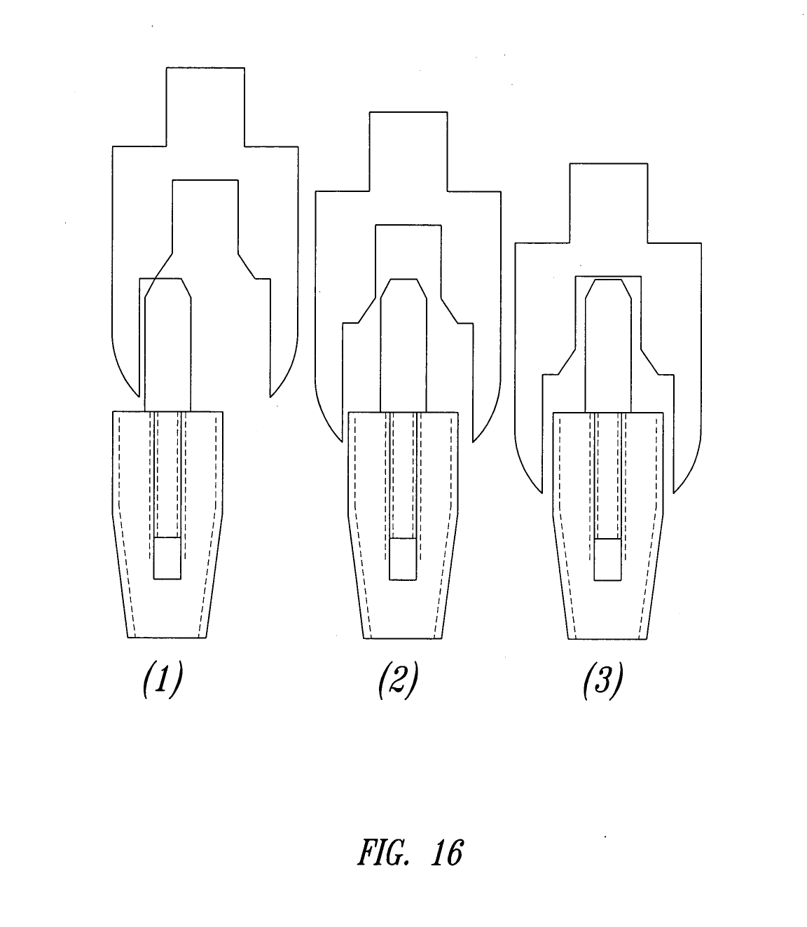

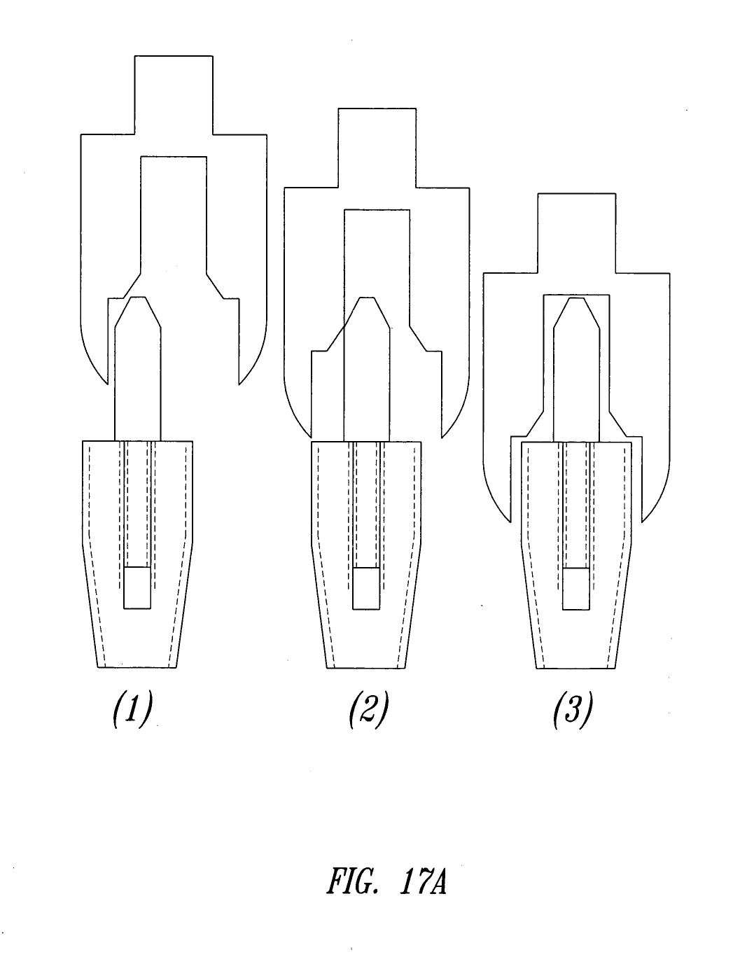

Another aspect of the present invention is a bone graft profiler tool, which may be used to remove tissue (such as deteriorated bone) in preparation for installation of any filler, such as a bone graft 600 or formable material 600. Such a bone graft profiler tool 300 is shown in FIGS. 4, and 12 through 17. The bone graft profiler tool 300 may be a substantially axisymmetric tool having an axis of symmetry 350 which is intended to at least approximately coincide with the axis 1150 of the alignment post 1100 and, by extension, the axis of the implant base 330. The cutting may take place in an axisymmetric manner, i.e., with the bone graft profiler tool tracing a surface of revolution about its own axis 350. The bone graft profiler tool 300 may comprise a gripped end suitable to be gripped by a rotary drive 390 and, connected to the gripped end, a cutting end.

On at least some of the external surface of its cutting end and/or at its tip, the bone graft profiler tool may comprise cutting features that assist it in cutting tissue (which may include bone). Such cutting features may include flutes, teeth, ridges, bumps, or other appropriate cutting features as are known in the art. The bone graft profiler tool 300 may be generally axisymmetric, but an exception is that the cutting features may not strictly satisfy the definition of axisymmetry.

The cutting features may be located in a pattern that may be periodic, with the cutting features repeating an integer number of times around the circumference of the bone graft profiler tool 300 at any given circumference of the bone graft profiler tool. The cutting features may be relatively small compared to the overall dimensions of the bone graft profiler tool 300. The bone graft profiler tool 300 may have at its end farthest from the gripped end a tip that may itself have teeth or other cutting features. Any of the cutting features may have peaks located farthest from the body of the bone graft profiler tool 300 such that all of the peaks lie on an enveloping surface which is axisymmetric and which is chosen to substantially equal the shape of profiled recess which is desired for the later installation of a filler such as a bone graft 600. This shape of the bone graft profiler tool 300 body or the enveloping surface may be frusto-conical, curved, parallel-sided, etc., or various of these shapes in various places.

In its interior at its cutting end, the bone graft profiler tool 300 may comprise a bone graft profiler tool internal recess 320 which may be symmetric around the axis of symmetry 350 of the bone graft profiler tool 300. The bone graft profiler tool internal recess may be dimensioned so that the implant base can fit inside the bone graft profiler tool internal recess to at least some depth. This allows cutting to be performed alongside implant base. The bone graft profiler tool internal recess may be generally cylindrical having a bone graft profiler tool internal recess inside diameter (ID/profiler/tool/internal/recess) that is chosen such that, relative to the implant base outside diameter of (OD/implant/base), the difference between these two diameters may be a prescribed clearance. For example, the two diameters may be chosen such that the clearance between the two diameters is large enough to easily permit relative motion between the bone graft profiler tool and the implant base, but small enough so that there is not any significant amount of unremoved tissue remaining attached to the implant base in places where cutting is performed. For example, the diameters may be chosen such that difference between these two diameters, (ID/profiler/tool/internal/recess)-(OD/implant/base), is between 0.1 mm and 0.5 mm.

In the axial direction, the bone graft profiler tool internal recess may be defined at least in part by a bone graft profiler tool internal recess roof which may be a radial surface forming a shoulder or a partial obstruction. More generally, the roof may be considered to be a point where the local inside diameter of the bone graft profiler tool internal recess becomes less than ODimplantbase. It is also possible for the entire roof to be angled, i.e., a portion of a cone, as discussed elsewhere herein. The distance from the tip to the roof may be considered the depth of the bone graft profiler tool internal recess.

The bone graft profiler tool 300 may further comprise, connected to the bone graft profiler tool internal recess, a further recess that may be called the alignment post internal recess 330. This alignment post internal recess 330 in the bone graft profiler tool 300 may be provided for those applications in which an alignment post is intended to be used and may be designed to cooperate with an alignment post as described elsewhere herein. The alignment post internal recess 330 may be generally cylindrical having an alignment post internal recess inside diameter that may have a defined relationship to the outside diameter of the cylindrical portion of the distal end of the alignment post. The alignment post internal recess may be further defined by an alignment post internal recess roof. This roof may define a depth of an alignment post-internal recess as illustrated in FIG. 11.

There are two aspects of describing the placement in space of the bone graft profiler tool 300 which may be of interest for the surgical procedure of the present invention. The term locating may be used here to refer to locating the bone graft profiler tool 300 with respect to the implant base 330 in the two directions that are perpendicular to the axis 350 of the bone graft profiler tool 300. The term orienting may be used here to refer to angularly orienting the axis 350 of the bone graft profiler tool 300 with respect to the axis 350 of the implant base 330, so that the two axes are substantially parallel to each other.

In regard to locating the bone graft profiler tool 300 with respect to the implant base 330, in general, the accuracy of locating one round object with respect to another, when one object having an outside diameter is inside another object having an inside diameter, is determined by the difference between those two diameters. If an alignment post is not used, then the maximum sideways clearance between the bone graft profiler tool 300 and the implant base 330 is the difference between the bone graft profiler tool 300 inside diameter and the implant base 330 outside diameter.

If an alignment post 400 is used, it is also possible that there is another relevant diametral difference, namely the diametral difference between the inside diameter of the alignment post internal recess 330 and the outside diameter of the cylindrical portion of the distal region 420 of the alignment post 330.

If there are two interactions involving two such sets of diameters each having its own diametral difference, then the possible relative motion is determined by whichever diametral difference is smaller. It may be desired that the clearance between the alignment post 400 and the alignment post internal recess 330 be the smaller of the two clearances so as to help prevent rubbing of the bone graft profiler tool 300 against the implant base 330. It may be that rubbing of the bone graft profiler tool 300 against the alignment post 400 is more acceptable because both of those items are disposable.

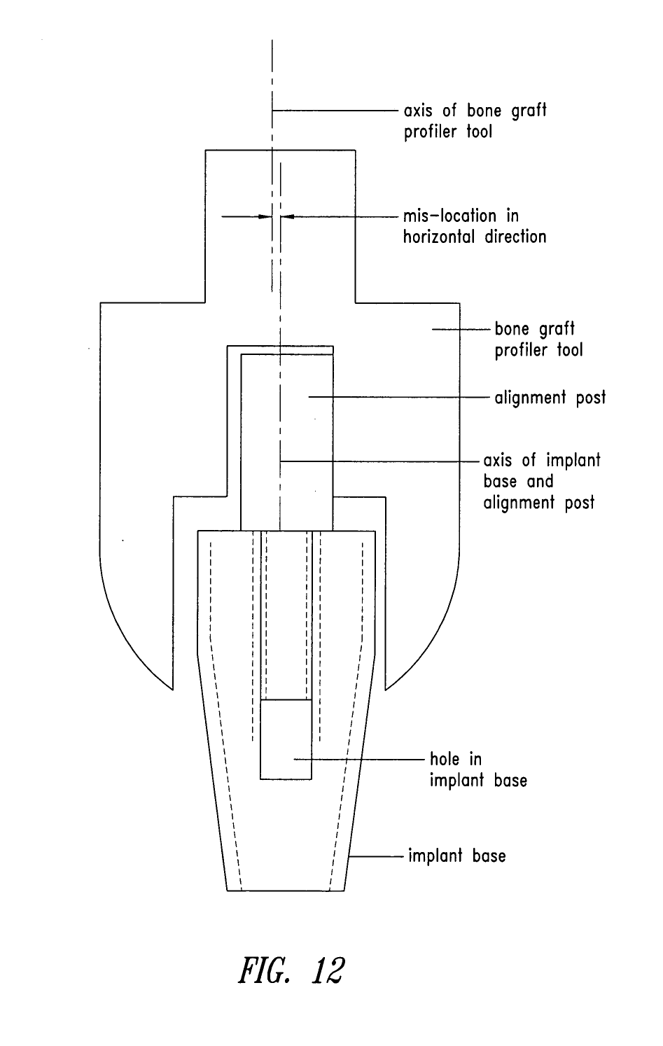

If the diametral clearance between the alignment post 400 and the alignment post internal recess 330 is smaller than the diametral clearance between the bone graft profiler tool internal recess 320 and the implant base 330, and if the alignment post 400 engages the alignment post internal recess 330 earlier than the bone graft profiler tool 300 comes into the vicinity of the implant post 330, then the alignment post 400 can essentially perform the entire locating function. In this case the bone graft profiler tool 300 may never actually touch any side surface of the implant base 330, which would help to prevent any possible scratching of the implant base 330 by the bone graft profiler tool 300. This situation is illustrated in FIG. 12.

Completely avoiding contact between the bone graft profiler tool 300 and the implant base 330 might also require additional constraints related to mis-orientation, as described elsewhere herein. On the other hand, it may be desired to size the various diameters and diametral differences so as to allow the bone graft profiler tool 300 to touch the implant base 330, such as for more complete removal of tissue from the implant base 330.

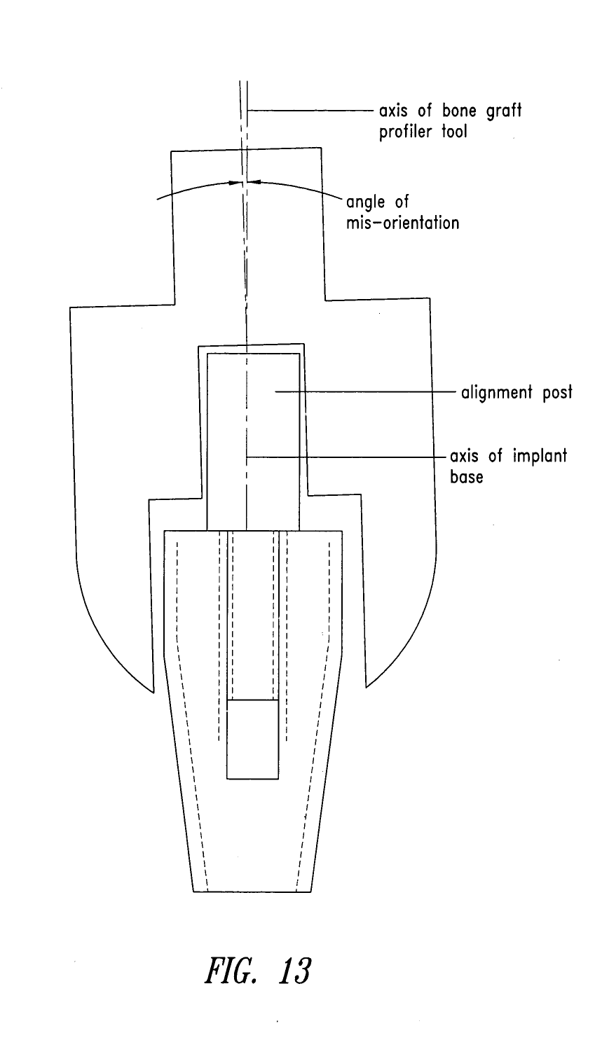

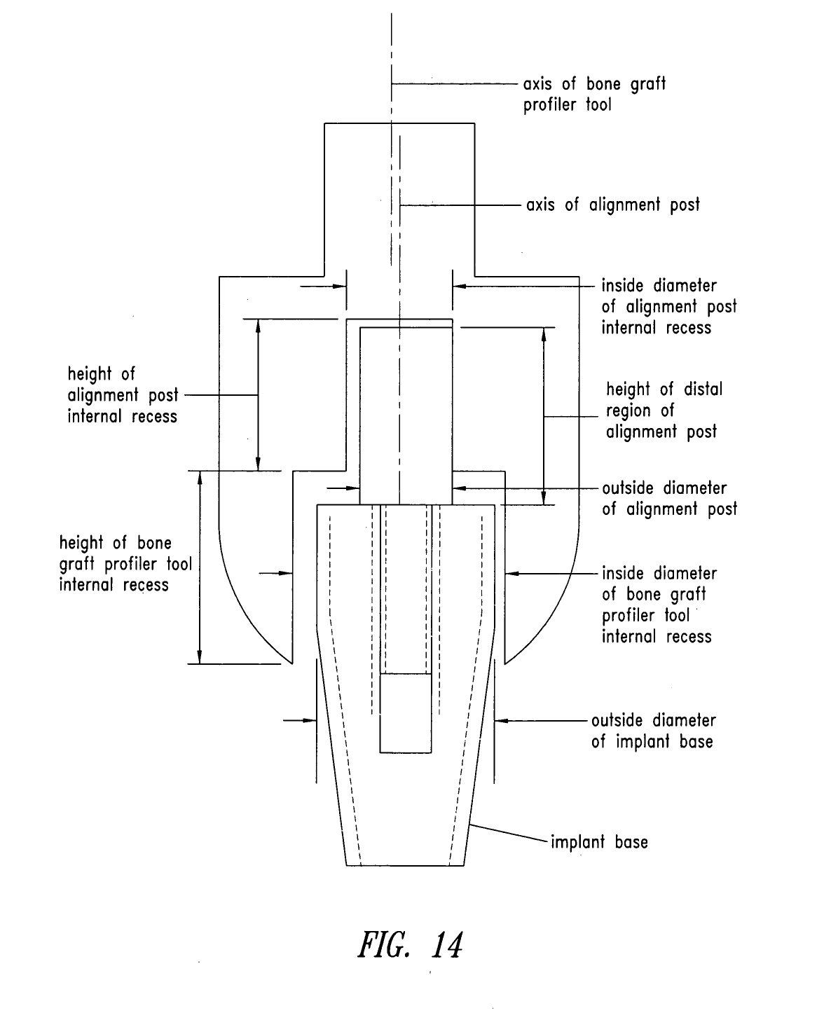

The contact or lack thereof between the bone graft profiler tool and the implant base can also be investigated for the situation of mis-orientation between the axes of bone the bone graft profiler tool and the implant base, as illustrated in FIG. 13. In general, the inaccuracy of orientation of two objects both having cylindrical features (one external and one internal) is a function of the diametral clearance between the features being engaged, divided by the length of engagement or overlap between the two features. One possible situation which may be designed for is that the orientation be determined primarily by the interaction between the alignment post 1100 and the alignment post internal recess 330, so that there is no rubbing of the bone graft profiler tool 300 against the implant base 330 even when there is maximum amount of mis-orientation of axes which is permitted by the various dimensions. This situation would serve to protect the implant base 330 from possibly being scratched by the bone graft profiler tool 300. This situation is illustrated in FIG. 13, in which bone graft profiler tool 300 is tilted to the maximum extent permitted by the alignment post 400.

It can be realized that for a given set of dimensions involving the alignment post 1100 and the alignment post internal recess 330, there is a maximum possible angle of mis-orientation that is determined by the diametral difference and the length of engagement of the alignment post 400 with the alignment post internal recess 330. More specifically, the tangent of the misalignment angle is the ratio of those two quantities. Once that angle is known, geometric calculations can be used to determine whether the tip of the bone graft profiler tool 300 will contact the side of the implant base 330. Depending on what is desired, the diametral difference between the bone graft profiler tool internal recess 320 and the implant base 330 can be sized so that contact either does or does not occur between the bone graft profiler tool 300 and the implant base 330. In FIG. 13, as illustrated, contact does not occur.

It is also possible, for the case where no alignment post is used, to calculate a possible angle of mis-orientation as a function of the diametral difference which is the inside diameter of the bone graft profiler tool internal recess 320 minus the outside diameter of the top of the implant base 330, divided by the length of engagement between the bone graft profiler tool and the implant base. In such a situation there would be rubbing between the bone graft profiler tool 300 and the implant base 330.

The design of the bone graft profiler tool 300 can also be used to control how far the bone graft profiler tool can advance into the surgical site. It can first of all be noted that for some surgeries or some surgeons, it may be desired not to place any substantial hardware limits on how far the bone graft-cutting tool can advance into the surgical site. In such a case, the depth of the bone graft profiler tool internal recess 320 may be chosen to be greater than any expected depth of cut and the depth of the alignment post internal recess (if an alignment post is used) could similarly be chosen to be rather large. This would provide the surgeon with a full range of options. In this case, it may be that judging the depth of cut is left to the discretion of the surgeon during the surgery.

In many instances, it may be desirable to provide some sort of a mechanical stop to pre-determine the distance by which the bone graft profiler tool 300 can advance into the tissue. Such a limit can be helpful to insuring that the prepared recess is suitably dimensioned for a pre-manufactured bone graft. One such possible stop to limit motion in the axial direction can be provided by the roof of the bone graft profiler tool internal recess 320 contacting the top of the implant base 330. However, this would involve possible rubbing of the bone graft profiler tool 300 against the top of the implant base 330, which is a surface that might need to be protected from damage. Accordingly, an alternative form of stop can be provided by the roof of the alignment post internal recess 330 contacting the top of the alignment post 1100, such as flat 1170. Appropriate dimensions could be designed so that contact occurs between the roof of the alignment post internal recess 330 and the top of the alignment post 1100 without there being any contact of the roof of the bone graft profiler tool internal recess against the top of the implant base 330. This would protect the top of the implant base 330 against rubbing and would insure that, to the greatest extent possible, any rubbing occurs between disposable components and not against the implant base 330. A height of the distal region 1120 of alignment post 1100 may be defined as the distance, when the alignment post 330 is fully inserted in the implant base 330, from the top of the alignment post 330 to the extreme distal end of the distal region 1120 of alignment post 100. The depth of the alignment post internal recess may be defined as the distance from the roof to the roof. A criterion for no contact against the top of implant base 330 is that the height of the distal end 1120 of alignment post 1100 be greater than the depth of the alignment post internal recess 330.

The depth of the bone graft profiler tool internal recess 320, or the depth of the alignment post internal recess 330 in conjunction with the height of the distal region 1120 of alignment post 1100, may be chosen uniquely for a particular patient depending, for example, on the patient's extent of bone resorption/deterioration.

It is also possible that some form of adjustable stop or suitable design feature may be provided elsewhere in the tooling or procedure.

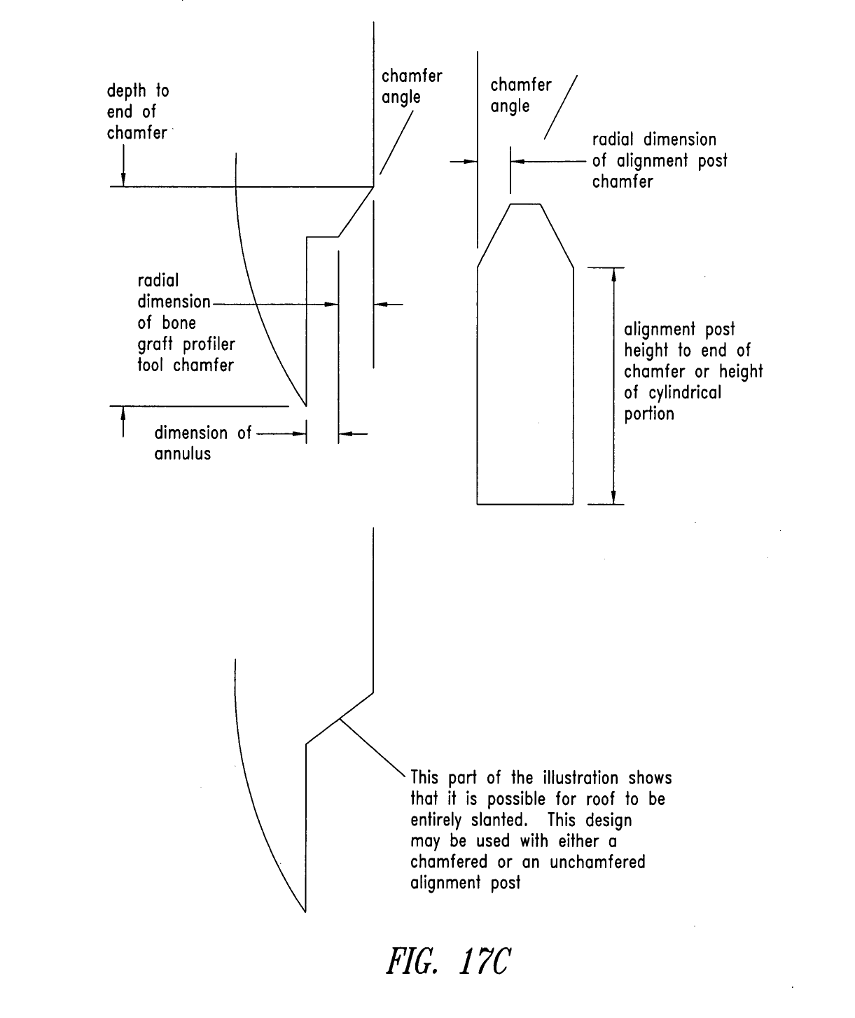

If the bone graft profiler tool 300 comprises a bone graft profiler tool internal recess and also an alignment post internal recess 330, there may be provided at the meeting of those two recesses a transition that is other than a sharp corner. The transition may, in general, be any appropriate axisymmetric curve or shape, and specifically may be a chamfer having a chamfer angle 362 as illustrated in FIG. 17C. The angle and linear dimensions of the chamfer inside the bone graft profiler tool may be selected suitably so that the chamfer can help the bone graft profiler tool to find its intended location as it advances onto the alignment post 1100. For example, the chamfer angle could be less than or approximately equal to 45 degrees, such as 30 degrees or 15 degrees. The exact value is not critical. This would provide an effect similar to that which may be provided by the possible chamfer 1160 on the alignment post 1100 that is described in connection with the alignment post. It is possible to use only a transition on the alignment post 1100, or only a transition on the bone graft profiler tool 300, or both transitions together. If both types of transitions are used together, that might accommodate greater inaccuracy in the initial guess as to the location of the bone graft profiler tool 300 than could be accommodated by the use of a transition on only one of the two parts.

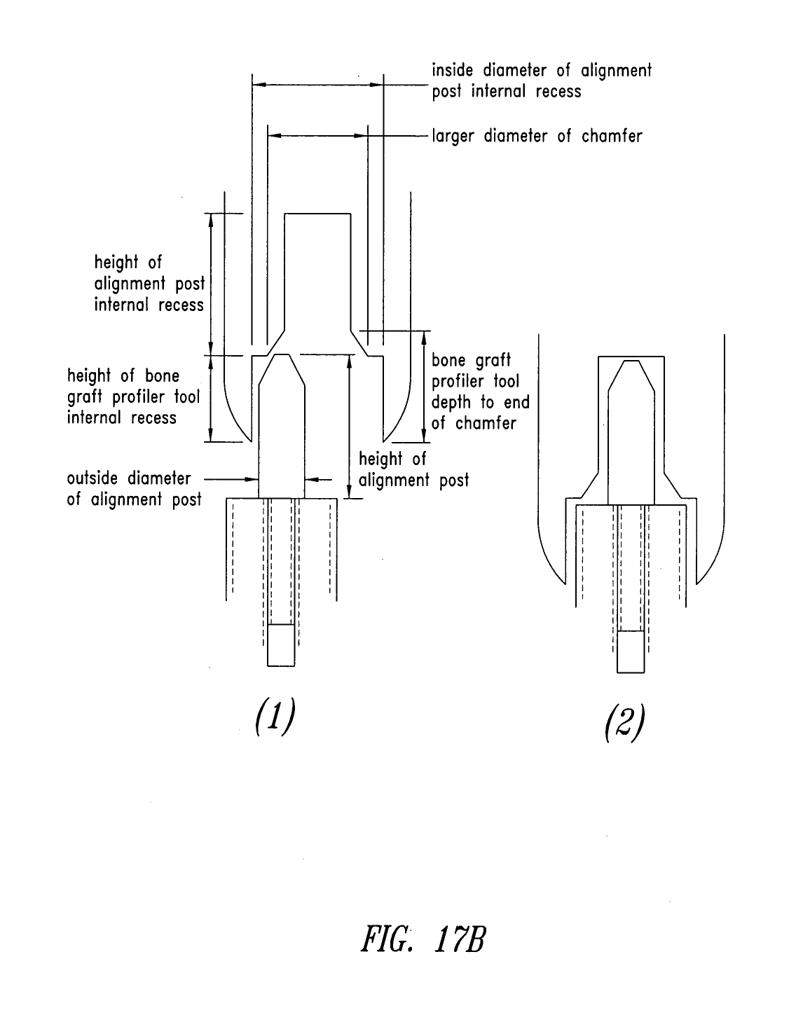

Two sets of chamfers and associated motions are illustrated in FIGS. 16 and 17. In both cases, the chamfer of the alignment post and the chamfer of the bone graft profiler have a chamfer angle and a chamfer radial dimension. It is of course possible that the two chamfer angles could be different from each other, but for sake of illustration in FIGS. 16 and 17A-C they are drawn as being equal to each other. FIG. 16 illustrates a combination of bone graft profiler tool 300 and alignment post 400; both chamfers having chamfer angles of 15 degrees, and which can accommodate a moderate amount of mis-location as illustrated. FIG. 17 illustrates a combination with slightly larger and more angular chamfers, with both chamfers having chamfer angles of 30 degrees. This situation can accommodate a greater amount of mis-location.

FIGS. 16 and 17 each show three points in the motion of bone graft profiler tool 300 toward implant base 330. FIGS. 16(1) and 17A(1) show the situation when the profiler chamfer and post chamfer are just beginning to encounter each other. After the two chamfers have begun to interact with each other, the chamfer of bone graft profiler tool can slide along the chamfer of the alignment post, as bone graft profiler tool moves in a diagonal path comprising both axial motion toward the implant base and radial motion toward a more correct location with respect to implant base 330.

FIGS. 16(2) and 17A(2) show the point where this motion is about to cease being diagonal motion, because the two chamfers are about to finish their interaction with each other, and the motion is about to become substantially only axial motion toward implant base, which involves the internal cylindrical surface of alignment post internal recess sliding along the external surface of the cylindrical portion of the distal end of alignment post. Such axial motion may continue until the situation shown in FIGS. 16(3) and 17A(3), in which the bone graft profiler tool has reached a stop, with the result that bone graft profiler tool cannot advance any further and cutting is complete.

FIG. 17, in particular, illustrates an ability to accommodate such a large amount of mis-location that it is possible to guarantee that the bone graft profiler tool will find its correct location as the bone graft profiler tool is advanced toward the implant base, with the only requirement being that alignment post is inside bone graft profiler tool internal recess. This situation should provide the greatest possible ease as far as achieving the proper location of bone graft profiler tool 300 relative to implant base. In order for the two chamfers to engage each other as shown even with maximum mis-location, the radial dimension of the flat region of the roof must be less than the horizontal dimension of the chamfer at the extreme distal end of alignment post. The radial dimension of the annulus can be taken to be the inside radius of the bone graft profiler tool internal recess minus the inside radius of the alignment post internal recess minus the radial dimension of chamfer.

It is also possible to achieve the desired goal if there is no flat region at all in roof, i.e., if the entire roof is slanted, which is also illustrated in FIG. 17. In this case it would not matter if the extreme distal end of the distal region of alignment post had any chamfer at all. It can also be observed in FIG. 17 that the dimensions along the axial direction may be chosen such that the bone graft profiler tool is fully located (in the direction perpendicular to the axis) (i.e., the chamfers have finished interacting with each other, and instead there is contact between the alignment post internal recess and the cylindrical part of the distal end of alignment post) before the tip reaches any axial position where the implant base exists at the same axial position. Thus, there would be no possible contact between bone graft profiler tool and implant base prior to completion of the process of locating bone graft profiler tool with respect to implant base.

A depth-to-chamfer dimension of the bone graft profiler tool may be defined as the axial distance from the tip to the point where alignment post internal recess becomes cylindrical rather than chamfered. A height-to-chamfer dimension of alignment post may be defined as the axial distance from shoulder (or, if there is no shoulder, the distance from the top of implant base upon full engagement of the alignment post) to the point where chamfer departs from the cylindrical portion of the distal region of alignment post.

The criterion for completion of alignment before interaction between the bone graft profiler tool and the implant base, i.e., that the tip of bone graft profiler tool avoid the corner of implant base, is that the height-to-chamfer dimension of alignment post be greater than the depth-to-chamfer dimension of bone graft profiler tool. Also illustrated in FIG. 17A(3) is the condition that the stop is determined by contact between the alignment post internal recess and the top of alignment post (instead of by contact between the bone graft profiler tool internal recess roof and the implant base), although this is not a necessary condition. For simplicity, FIGS. 16 and 17 do not illustrate any mis-orientation, which would likely worsen the situation as far as the likelihood of contact between bone graft profiler tool and implant base.

In all of these respects, individual surgical situations and surgeon preferences may dictate how much clearance should be provided as far as location (diametral difference) and how much mis-orientation should be allowed, whether an alignment post should be used, whether or not the bone graft profiler tool should be allowed to contact the implant base, and even whether or not stops should be built in to the design of the bone graft profiler tool in possible cooperation with the alignment post.

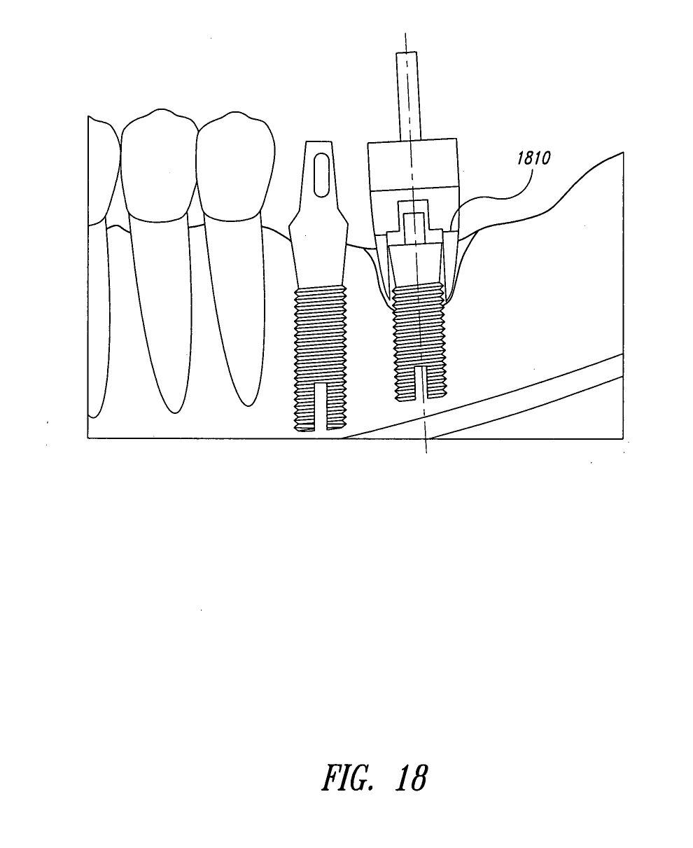

As shown in FIG. 18, the bone graft profiler tool 300 may comprise a mark 1810 on its external surface that indicates any desired dimensional information. The mark 1810 may, for example, indicate the position of the roof of the bone graft profiler tool internal recess. The mark 1810 may indicate the expected position of the top of the implant base 330 when the bone graft profiler tool 300 is in contact with its stop (which may be any of the various designs of stops discussed herein, including for example a stop formed by the roof 332 of the alignment post internal recess 330 contacting the top of the alignment post). There may be multiple marks indicating any desired dimensional information. Such marks may be small grooves going around the external circumference of the bone graft profiler tool 300, as illustrated in FIG. 18.

Discussion up until now has described a bone graft profiler tool which has an axis of symmetry and whose cutting region forms a complete circumference of the bone graft profiler tool, with the cutting region completely surrounding and defining the bone graft profiler tool internal recess. That is one possible design, but not the only possible design of bone graft profiler tool. It can be understood that a bone graft profiler tool with a complete circumference visually obstructs the view of the surgical site while cutting is being performed. Similarly after cutting has stopped, in order to view the profiled recess it is necessary to remove the bone graft profiler tool from the vicinity of the surgical site. It may be desirable to have better visual access to the surgical site when the bone graft profiler tool is in the vicinity of the surgical site.

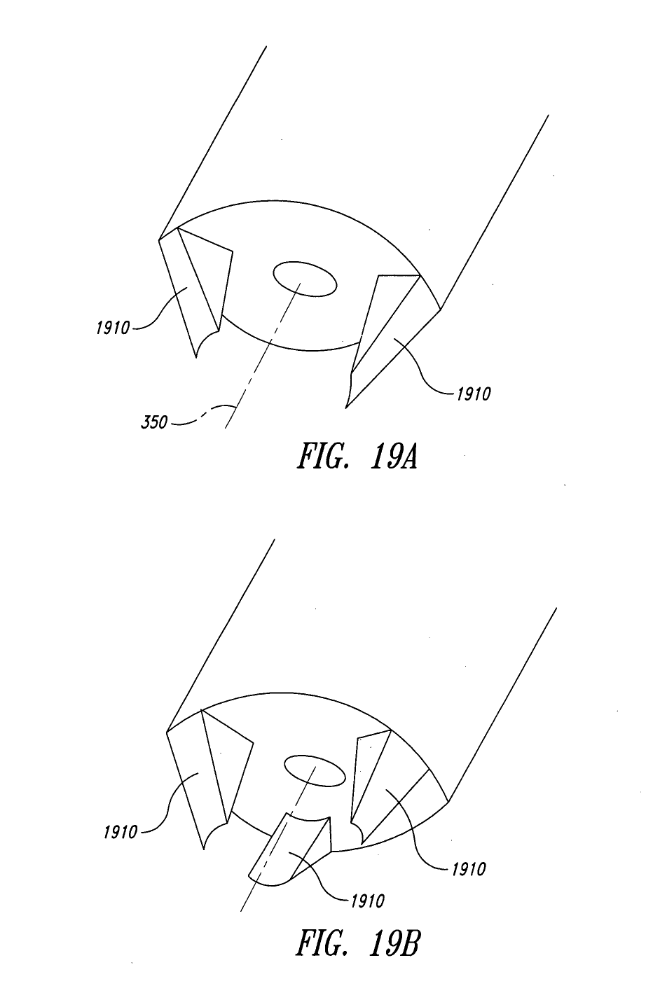

Accordingly, it is also possible to design a bone graft profiler tool as shown in FIGS. 19A and 19B with a cutting region which is interrupted. Such a bone graft profiler tool may comprise a small number of blades 1910, such as two or three or four blades, which may be spaced equidistantly around the circumference, and which, by their rotation around axis 350 of bone graft profiler tool 300, trace out the desired profiled recess 730. By virtue of the space between the blades 1910, there is provided some visual access to the surgical site even when the bone graft profiler tool is in the vicinity of the surgical site. It may be that when the bone graft profiler tool comprising blades 1910 is rotating, some visual access of the entire circumference is provided. When the bone graft profiler tool comprising blades 1910 is at rest, visual access is provided to the portion of the circumference between blades 1910, while access to the rest of the circumference is blocked.

This design having individual blades 1910 can be used in conjunction with an alignment post 1100 and may comprise an alignment post internal recess 330, although it is not essential that an alignment post be used. It is possible that the blades 1910 can individually emerge from the body of the bone graft profiler tool at the elevation of the roof as illustrated. Alternatively, it is possible that there could be some amount of solid exterior between the roof and the place where the blades 1910 emerge individually. It is also possible that material could be deleted from the bone graft profiler tool 300 in other places to improve visual access.

In all of the bone graft profiler tool designs described herein, the non-cutting end of the bone graft profiler tool may be suitable to be gripped in an appropriate rotary drive, as is known in the art. The bone graft profiler tool may be provided with passageways (not shown) for carrying a liquid such as water and introducing the liquid near the locations where cutting is taking place, as is known for conventional cutting tools for treatment of cavities in natural teeth. The bone graft profiler tool may be made of a material that is biocompatible and corrosion resistant and of sufficient hardness to cut bone and other tissue. Such a material may be stainless steel or other known suitable metals. The bone graft profiler tool may be sterile and may be packaged so as to remain sterile until the time when it is used.

Bone graft

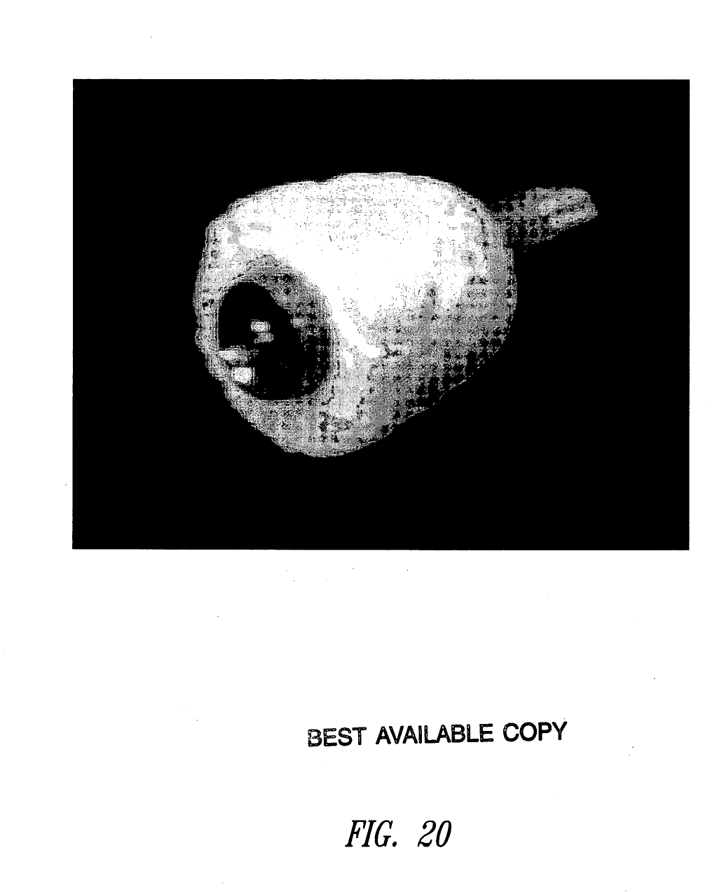

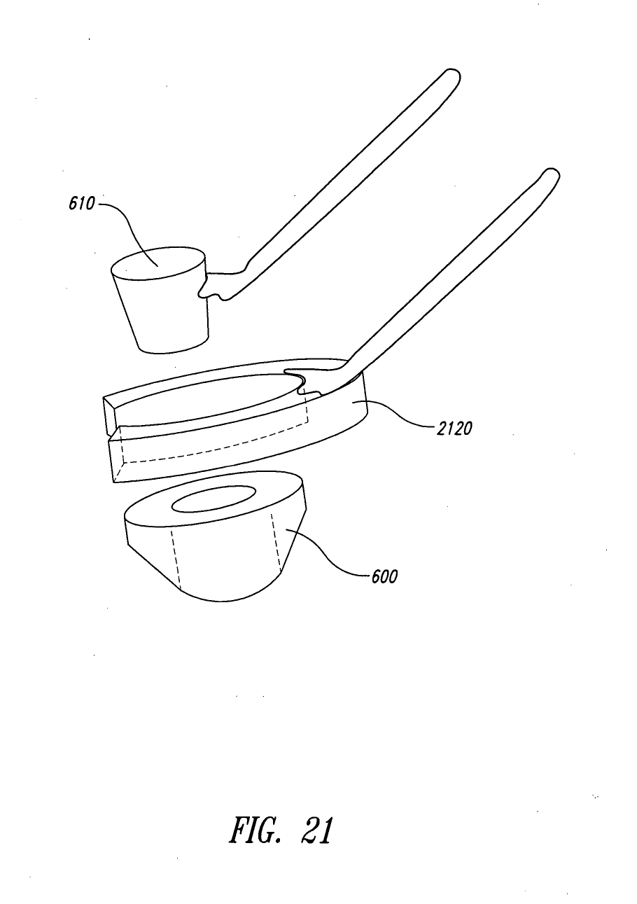

Another aspect of the present invention is the bone graft itself. Such a bone graft is shown in FIG. 20. As used herein, the term bone graft is intended to include both natural bone (from any source), and porocessed components of natural bone, and synthetic material of all kinds, and combinations thereof, in a form that has a definite shape. Some specific types of bone graft are an aspect of the present invention. The bone graft of the present invention may be described both by its geometry and by its material composition.

The bone graft may be made of a rigid material, so it can have definite dimensions. One possibility is that the bone graft may be made in a non-specific shape intended to be shaped during surgery by removing material from it.

Another possibility is that the bone graft may be a pre-formed article made to approximate dimensions but may modified during surgery by removing material from it in local places for dimensional adjustment. Another possibility is that the bone graft may be made to patient-unique dimensions in advance of surgery so exactly that no adjustment or removal of material from it need be made during surgery.

The bone graft may comprise a hole in its middle suitable to fit around the implant base, giving the bone graft an annular shape that may be characterized by a bone graft inside diameter. This bone graft inside diameter may be just slightly larger than the maximum outside diameter of the top of implant base which the bone graft is intended to fit around, so that the bone graft can slide into place over the implant base. The bone graft may be axisymmetric, with hole being located on the axis of symmetry. On the other hand, if needed for the geometry of the deteriorated bone at a particular site in a particular patient, the bone graft may be non-axisymmetric.

The external shape of the bone graft may be frusto-conical, conical with curvature, sharp-edged, or in general any shape deemed appropriate for treatment of a particular site in a particular patient. The external shape of the bone graft may be substantially identical to the shape of the bone graft profiler tool or may have a prescribed geometric relationship to the shape of the bone graft profiler tool, for example, so as to achieve a prescribed fit with respect to the recess created by the bone graft profiler tool.

For example, the bone graft could have a predetermined gap, which may everywhere be maintained to within a close tolerance, with respect to the prepared recess, or the bone graft could have a predetermined amount of interference, which may everywhere be maintained to within a close tolerance, with respect to the prepared recess. With the bone graft manufacturing process and the bone graft profiler tool and the surgical methods described herein, it is believed that a tolerance of better than 0.4 mm may be achieved on the relative dimensions of the bone graft and the recess. This tolerance may be applied in the form of either gap or interference as desired, or even a combination of gap in some places and interference in other places. The bone graft may include features that are conducive to gripping of the bone graft as it is carried to or installed in the recess created in the bone.

It is possible that the bone graft may be created in more than one piece that together make up the described shape. Manufacture of a multi-piece bone graft using methods of the present invention (as described elsewhere herein) is essentially as easy as manufacture of a single-piece bone graft, as long as appropriate software instructions for 3DP can be generated. Similarly, manufacture of a non-axisymmetric bone graft using the manufacturing methods of the present invention (as described elsewhere herein) is essentially as easy as manufacture of an axisymmetric bone graft, as long as appropriate geometric description is available and as long as appropriate software instructions for 3DP can be generated.

It would also be possible to make a bone graft as described which fits over more than one implant base in a patient's mouth so as to repair more than one ailing/failing implant using a single bone graft. The bone graft may comprise channels within itself.

The bone graft may comprise channels or patterns on its surface that is intended to face the recess. The bone graft may comprise composition that is different at the intended surface as compared to elsewhere in the bone graft. If it is desired that the bone graft have a geometry or composition at its surface which is different from its geometry or composition interiorly of the surface, then the combination of various aspects of the present invention, including the ability to custom-manufacture a bone graft with prescribed detail, and the ability to create a recess precisely corresponding to that bone graft design, provides confidence that there will not be a need to remove material from, and thereby disturb the designed surface features of, the bone graft.

In terms of material composition, the bone graft may be porous. The bone graft comprises a matrix material that exists in the form of particles joined to each other so as to form a three-dimensionally interconnected network. The matrix material may be or may include a synthetic material. The matrix may be made of a ceramic material that may resemble materials found in natural bone and in particular may be a compound comprising calcium and phosphorus.

If the bone graft is made entirely of synthetic material, that would avoid the possibilities of disease transfer associated with the use of donor bone (allograft) and would avoid the second site surgery associated with autograft. The matrix material may be nonresorbable. Such a bone graft may be made of or may include nonresorbable hydroxyapatite. The property of nonresorbability may be useful for combating a situation in which natural bone has resorbed. A nonresorbable material that is porous may tend to remain permanently in place while still allowing or encouraging natural bone to grow into its void spaces, thereby resulting in a combination of at least some of the strength of natural bone together with a tendency not to resorb.

Alternatively, the matrix material may be resorbable or have a resorbable component. In this situation, the material may be or may include tricalcium phosphate. It is possible that both nonresorbable and resorbable materials may be used in the bone graft. The matrix material may be ceramic, as just described. Alternatively, it is also possible that the matrix material may be or may comprise demineralized bone matrix (DBM), with particles of DBM being joined by a binder substance. In yet another alternative embodiment, the matrix material may include polymer particles.

Because the matrix may be porous, it may have pores that may be three-dimensionally interconnected. The porosity and the pore size or pore size distribution may be chosen so as to encourage natural bone to grow into the bone graft. The matrix of the bone graft may have pores whose size is compatible with natural bone. The porosity of the bone graft, which is the fraction of space not occupied by the matrix, may be in the range of from 20% void to 60% void. The matrix may contain both HA and TCP, and the proportions of those two substances may vary from one place to another.

The bone graft may further include at least one other material occupying at least some of the pores of the matrix. The bone graft may be osteoconductive or osteoinductive and may comprise additives to give it properties of osteoconduction or osteoinduction, for example, additives which occupy at least some of the pores of the bone graft. The bone graft may include demineralized bone matrix (DBM) occupying some of the pores of the matrix. Additive material can include the patient's own blood products, and any of a number of possible growth-stimulating or biological additives, as described in the patent application referenced below.

The pores in the matrix of the bone graft may be partially or fully occupied by a polymer, which may be either resorbable or nonresorbable. An example of a resorbable polymer is poly lactic co-glycolic acid (PLGA), and others are given in the patent application referenced below. The polymer may be or may include a comb polymer, as described in U.S. Pat. No. 6,350,459 and elsewhere. The presence of material occupying space in the pores of the matrix may be uniform throughout the bone graft or may be concentrated unequally in certain regions of the bone graft.

With regard to its material composition, its design and any other aspects, the bone graft may include any of the features, properties and the like, which are described in U.S. patent application Ser. No. 60/286,564, which is hereby incorporated by reference.

FIG. 20 is a photograph of a bone graft of the present invention, placed around an actual implant base in approximately the position it would occupy with respect to the implant base as a result of the procedure described herein.

Method of Manufacture of Bone Graft

The bone graft of the present invention may be manufactured by methods that include three-dimensional printing (3DP). Three-dimensional printing described in U.S. Pat. No. 5,204,055 and elsewhere, is the manufacture of objects by assembling them from powder in a layer-by-layer fashion. FIG. 1 illustrates one exemplary three-dimensional printing apparatus 100 in accordance with the prior art. The apparatus 100 includes a roller 160 for rolling powder from a feed bed 140 onto a build bed 150. Vertical positioners, 142 and 152 position the feed bed 140 and the build bed 150 respectively. Slow axis rails 105, 110 provide support for a printhead 130 in the direction of slow axis motion A, and fast axis rail 115 provides support for the printhead 130 in the direction of fast axis motion B. The printhead 130 is mounted on support 135, and dispenses liquid binder 138 onto the build bed 150 to form the three-dimensional object.

In selected places powder particles are joined to other powder particles and to other bound regions by the action of a binder liquid that may be dispensed from a dispenser that may resemble an ink-jet printer. Binding can occur as a result of a non-volatile substance being deposited by the binder fluid, or can occur as a result of dissolution of powder particles followed by re-solidification. Unbound powder supports bound regions and can later be removed after completion of 3DP. If appropriate software instructions are provided, geometrically complicated articles including nonaxisymmetric articles can be made essentially just as easily as simple or axisymmetric articles can be made.

Implantable bone substitutes can be made by using powder that is a ceramic substance that may resemble substances found in natural bone. Such articles may involve a sintering step after the completion of 3DP. The sintering may be partial sintering, which may be carried out at a combination of temperature and time such that the powder particles partially join to each other and yet leave some porosity between them. During the heating leading up to partial sintering, the binder substance may exit from the article in the form of vapor or gaseous decomposition products. During partial sintering the powder particles themselves may soften so as to partially join each other, while still leaving a controlled amount of porosity between them.

Implantable bone substitutes can also be made of or can contain non-ceramic substances including demineralized bone matrix (DBM) and polymers. If a ceramic-sintering step is used, it is likely to be the highest-temperature step in the entire manufacturing sequence, and to be the step that is incompatible with organic substances.

It is also possible that the bone graft may be made by spreading powder which is or comprises demineralized bone matrix (DBM), i.e., DBM would be the matrix material, and joining those powder particles to each other using a binder substance. Because of the temperature limitations of DBM, the manufacture of such an article would not involve sintering at elevated temperature.

Addition of biological substances, polymers and other temperature-sensitive substances to the bone graft may be performed after the sintering step if a sintering step is used, or after the basic 3DP-manufacturing step. Such addition of biological substances may be performed, for example, by dipping the bone graft into a solution or by infusing liquid into some or all of the bone graft. In the case of polymers, the polymer may be dissolved in a solvent such as chloroform, which may then be allowed to evaporate.

Carrier

Another aspect of the invention is a carrier that is suitable to engage with a portion of the bone graft so as to help transport the bone graft 600 to its intended position at the surgical site. Such a carrier 610 is shown in FIG. 21. The carrier 610 may be made of a resilient material so that the carrier 610 fits onto a portion of the bone graft 600 in such a way that the resilient material is deformed, thereby creating frictional force between the carrier and the bone graft. The carrier 610 may be designed so that the gripping force that the carrier 610 exerts on the bone graft 600 is small enough to avoid damaging the bone graft 600. The carrier 610 may be made so as to fit, with a slight interference fit, either inside the interior hole of the bone graft 600 (shown by carrier 610) or at least partway around the outside of the bone graft 600 (shown by carrier 2120), at the end of the bone graft 600 which is the end closest to the mouth cavity in the intended installed position of the bone graft 600. The carrier 610 may be made of materials which are suitable for use in and around the mouth and may be sterile and packaged either together with the bone graft 600 or separately, in a way suitable to maintain sterility until the time of use.

Kit

Another aspect of the present invention is a kit comprising components that may be useful during the described surgical procedure. The kit may comprise one or more bone graft profiler tools. Appropriate dimensions of the bone graft profiler tools may be chosen for a particular patient so as to match the dimensions of the particular implant base which already exists in the patient's bone. For example, the bone graft profiler tool or tools may have an inside diameter of the bone graft profiler tool internal recess, which is dimensionally matched to the outside diameter of the implant base already existing in the patient's bone, as described elsewhere herein. Other dimensions of the bone graft profiler tool may be chosen so as to match the degree of bone recession/degradation around a particular implant base in a particular patient, as may be determined in advance of surgery by radiographic means.

In the case of multiple bone graft profiler tools, the inside diameter of the bone graft profiler tool internal recess may be the same for all of the tools. A set of various bone graft profiler tools may be chosen to have a sequence of external dimensions chosen to progressively excavate the recess as desired. Dimensions of the bone graft profiler tool(s) and dimensions of the bone graft could be coordinated with each other. Alternatively, groups of bone graft profiler tools may be provided that differ only in the depth of cutting of each tool, as described elsewhere herein.

Alternatively, the kit may comprise a wide variety of bone graft profiler tools such as to cover most of the situations likely to be encountered, giving the surgeon the ability to choose between various bone graft profiler tools 300 during surgery. The kit may also include alternative bone graft profiler tools for cutting away deteriorated bone to dimensions other than the dimensions anticipated during surgical planning, if conditions encountered during actual surgery so indicate.

It is also possible to create a kit comprising a variety of different sizes of bone graft profiler tools. For example, matched to any particular outside diameter of implant base may be an assortment of bone graft profiler tools each having a particular depth of cut. A similar assortment could be provided for each of various implant base outside diameters that might be encountered in patients. The kit may include groups of bone graft profiler tools that are not related to each other by any intended sequence of use. The kit may include tools such as burrs for localized cutting.

The kit may comprise at least one bone graft intended for implantation in the patient. The dimensions of the bone graft(s) may be coordinated with any or all of appropriate dimensions of the bone graft profiler tool(s); dimensions of the implant base; and the measured degree of bone resorption/degradation in the patient. In addition to a first bone graft intended for implantation into the patient, the kit may further include a duplicate bone graft in case of unexpected findings or breakage of the first bone graft during surgery. The kit may include a bone graft that is oversized, or even a featureless block of material, any of which could be cut to fit during surgery if needed.

If the cutting procedure uses an alignment post for aligning and/or orienting the bone graft profiler tool with respect to the implant base, the kit may include at least one alignment post as described elsewhere herein, and may further include at least one tool for installing or tightening or untightening the alignment post in the implant base. The kit may include a carrier for transporting the bone graft into the recess that may be prepared for it during the surgical procedure.

The kit may further include templates or guides for various steps of the surgery, as appropriate. The kit may include a surgical membrane such as GoreTex or collagen suitable to block the growth of soft tissue in desired places. The kit may include surgical screws suitable for attaching the bone graft, and tools suitable for installing the surgical screws. The kit may further include suture materials. The kit may further include formable filler materials suitable for filling possible gaps between the bone graft and adjacent bone, or, alternatively, for use as the entire filler material. The kit may further include antiseptics and/or antibiotics. The kit may be designed so that it, or appropriate components of it, are sterilize and packaged or otherwise maintained in a sterile condition.

Further Comments

It can be appreciated that the bone graft of the present invention is a synthetic material conducive to the ingrowth of natural bone that has not heretofore been available for use in the repair of implant bases. The described bone graft is a solid (on the overall size scale) synthetic (or partially synthetic?) of synthetic matrix material, is conductive to the ingrowth of natural bone, and the hydroxyapatite itself does not resorb, meaning that the bone graft will not completely disappear. The bone graft can include an extent of designed detail, as far as geometry or composition, which has not heretofore been available.

It can also be appreciated that the described procedure and tools and articles improve the amount of planning and dimensional determination that can be done in advance of surgery. This can potentially improve the quality of fit between the bone graft and the recess that is prepared for the bone graft, and decrease the duration of surgery, and should in general improve surgical outcome. The bone graft can be manufactured ahead of time to exact patient-unique dimensions and those dimensions can be coordinated with the dimensions of the prepared recess by the use of the bone graft profiler tool. The bone graft profiler tool prepares, quickly and easily, an accurately dimensioned and aligned recess suitable to accept the bone graft. The dimensioning of the tool or tools may provide the ability to create a desired recess during surgery with little or no unplanned cutting-to-fit or adjustment during the surgical procedure.

It can also be appreciated that the simultaneous use of multiple aspects of the present invention provides abilities not heretofore available. For example, it becomes possible to design and manufacture a bone graft of precise dimension which has known geometry or composition at those surfaces which are intended to abut the natural bone of the prepared recess, and some other different geometry or composition internally, and to be confident that the prepared recess will match closely with the pre-manufactured surface of the bone graft and that there will not be a need to remove material from the surface of the bone graft (which might alter the designed surface geometry or composition) for purposes of fitting.

One advantage of the present invention is that due to the custom fitted graft, precise site preparation and placement of the graft, and composition of the graft; a better host response is received, thus lowering the morbidity rate with respect to the graft. The composition of the graft of the present invention provides improved wicking of the patient's cells, thus allowing cells to infiltrate the graft faster and with greater efficiency. The combination of a custom fit and an enhanced cell response results in a better union between the new graft and the host bone. Currently, the single most common reason for grafts to fail is because there is movement of the graft, causing a lack of adherence to the host bone and a failure of the graft. The present invention provides an improved graft for limiting movement by providing a custom fit to the graft site, and a composition that facilitates cell infiltration of the host cells into the graft thus securing the union between the host bone and the graft.

All patents and applications cited above are incorporated by reference in their entirety. Furthermore, the provisional patent application and non provisional patent application entitled Method of Manufacture, Installation, and System for a Sinus Lift Bone Graft, filed Feb. 26, 2003 and Feb. 26, 2004, respectively; provisional patent application and non provisional patent application entitled Method of Manufacture, Installation and System for an Alveolar Ridge Augmentation Graft, filed Feb. 26, 2003 and Feb. 26, 2004, respectively, are both herein incorporated by reference in their entirety.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. Aspects of the invention can be modified, if necessary, to employ the process, apparatuses and concepts of the various patents and applications described above to provide yet further embodiments of the invention. These and other changes can be made to the invention in light of the above detailed description.

From the foregoing it will be appreciated that, although specific embodiments of the invention have been described herein for purposes of illustration, various modifications may be made without deviating from the spirit and scope of the invention. In general, in the following claims, the terms used should not be construed to limit the invention to the specific embodiments disclosed in the specification and the claims, but should be construed to include all methods, apparatus and articles that operate under the claims. Accordingly, the invention is not limited by the disclosure, but instead the scope of the invention is to be determined entirely by the following claims.

1. A method of repairing an endosseous implant, including an implant base having an implant base axis, an abutment post joined to the implant base, and a tooth prosthesis joined to the abutment post, the method comprising:
removing the tooth prosthesis;
removing the abutment post;
resecting gingiva to expose tissue near the implant base;
cutting away tissue appropriate to create a desired recess by rotating a bone graft profiler tool around an axis which is at least approximately the implant base axis; and
installing, in the recess, a filler suitable to substantially fill the recess.

2. The method of claim 1, wherein the step of cutting away tissue includes a bone graft profiler tool having at least one dimension which is selected based on a dimension of the implant base.

3. The method of claim 1, wherein the step of cutting away tissue includes a bone graft profiler tool having at least one dimension that is selected based on characteristics of a particular site in a particular patient.

4. The method of claim 3, wherein the characteristics are determined by radiography in advance of surgery.

5. The method of claim 1, wherein the cutting away comprises locating the bone graft profiler tool with respect to the implant base.

6. The method of claim 1, wherein the cutting away comprises inserting into the implant base an alignment post, and wherein the cutting comprises locating the bone graft profiler tool with respect to the alignment post.

7. The method of claim 1, wherein the cutting away comprises orienting the bone graft profiler tool with respect to the implant base.

8. The method of claim 1, wherein the cutting away comprises inserting into the implant base an alignment post, and wherein the cutting comprises orienting the bone graft profiler tool with respect to the alignment post.

9. The method of claim 1, wherein the cutting away comprises limiting a depth of cut by contact of a portion of the bone graft profiler tool with the implant base.

10. The method of claim 1, wherein the cutting away comprises inserting into the implant base an alignment post, and wherein the cutting away comprises limiting a depth of cut by contact of a portion of the bone graft profiler tool with a top of the alignment post.

11. The method of claim 1, wherein the cutting away comprises using more than one bone graft profiler tool in succession.

12. The method of claim 1, wherein the cutting away comprises using the bone graft profiler tool followed by using a localized cutting tool.

13. The method of claim 1, further comprising, after the cutting away, applying antiseptic and/or antibiotic.

14. The method of claim 1, further comprising, after installing the bone graft, applying a surgical membrane.

15. The method of claim 1, further comprising, after all other steps, installing an abutment post which may be the abutment post removed earlier; installing a tooth prosthesis which may be the tooth prosthesis removed earlier; and putting the resected gingiva back in place.

16. The method of claim 1, wherein the filler is a formable material.

17. The method of claim 1, wherein the filler is a bone graft comprising a rigid material.

18. The method of claim 17, wherein the filler comprises synthetic material.

19. The method of claim 17, wherein the filler comprises demineralized bone matrix.

20. The method of claim 17, further comprising, after the cutting away, applying a formable filler material between the bine graft and the recess.

21. The method of claim 17, further comprising, after installing the bone graft, attaching the bone graft.

22. The method of claim 17, wherein the bone graft has at least one dimension which is selected based on characteristics of a particular site in a particular patient.

23. The method of claim 17, wherein the bone graft has at least one dimension which is selected based on a dimension of the implant base.

24. The method of claim 17, wherein the bone graft profiler tool has at least one dimension which is selected based on a dimension of the bone graft.

25. A method of repairing an endosseous implant which comprises an implant base, an abutment post joined to the implant base, and a tooth prosthesis joined to the abutment post, the method comprising: removing the tooth prosthesis; removing the abutment post; resecting gingiva to expose the implant base and bone or tissue near the implant base; cutting away tissue appropriate to create a desired recess; and installing, in the recess, a pre-formed bone graft comprising synthetic material or demineralized bone matrix.

26. The method of claim 25, wherein the bone graft is dimensioned to patient-specific dimensions prior to surgery.

27. The method of claim 25, wherein the cutting away comprises using a bone graft profiler tool.

28. The method of claim 25, wherein the cutting away comprises using a localized cutting tool.

29. The method of claim 25, wherein the cutting away comprises using a bone graft profiler tool followed by using a localized cutting tool.

30. The method of claim 25, further comprising, after the cutting away, applying antiseptic and/or antibiotic.

31. The method of claim 25, further comprising, after installing the bone graft, attaching the bone graft.

32. The method of claim 25, further comprising, after installing the bone graft, applying a surgical membrane.

33. The method of claim 25, further comprising, installing an abutment post which may be the abutment post removed earlier; installing a tooth prosthesis which may be the tooth prosthesis removed earlier; and putting the resected gingiva back in place.

34. A bone graft profiler tool comprising: a body which is substantially axisymmetric around an axis of symmetry; and, connected to the body, a gripped end suitable to be gripped by a rotary drive; and connected to or integral with the body, cutting features, wherein the bone graft profiler tool is able to rotate around the axis of symmetry and wherein the body and the cutting features are dimensioned suitably to create a desired axisymmetrically-shaped recess around an implant base.

35. The bone graft profiler tool of claim 34, wherein the cutting features are part of a connected structure which extends around a complete circumference.

36. The bone graft profiler tool of claim 35, wherein the connected structure defines an interior recess in the body, the interior recess being substantially cylindrical having symmetry around the axis of symmetry and being dimensioned suitably to accept a portion of an implant base.

37. The bone graft profiler tool of claim 35, wherein each cutting feature has a peak which is farthest from the body of the bone graft profiler tool, and wherein the peaks all lie on a surface of revolution which is centered on the axis of symmetry of the bone graft profiler tool.

38. The bone graft profiler tool of claim 35, wherein the cutting features repeat in a periodic pattern an integer number of times in a circumference of the bone graft profiler tool.

39. The bone graft profiler tool of claim 35, wherein the cutting features are flutes, teeth, ridges or bumps.

40. The bone graft profiler tool of claim 34, wherein the cutting features are not part of a connected structure which makes a complete circumference.

41. The bone graft profiler tool of claim 40, wherein the cutting features are part of individual blades.

42. The bone graft profiler tool of claim 40, wherein the individual blades are spaced equidistantly from each other around a circumference of the body.

43. The bone graft profiler tool of claim 42, wherein the number of blades is two or three or four.

44. The bone graft profiler tool of claim 34 wherein the body and the cutting features define an external surface of revolution centered on the axis of symmetry, and the body and cutting features are dimensioned based on characteristics of a particular site in a particular patient.

45. The bone graft profiler tool of claim 44, wherein the characteristics of a particular site in a particular patient are determined radiographically.

46. The bone graft profiler tool of claim 34, wherein the bone graft profiler tool internal recess has a bone graft profiler tool internal recess inside diameter which is larger than an outside diameter of the implant base by between approximately 0.2 mm to 0.5 mm.

47. The bone graft profiler tool of claim 34, wherein no stop is provided within an anticipated range of depth of cutting.

48. The bone graft profiler tool of claim 34, wherein the bone graft profiler tool internal recess comprises a bone graft profiler tool internal recess roof.

49. The bone graft profiler tool of claim 48, wherein the internal recess roof can contact a top of the implant base to limit an advancement distance of the bone graft profiler tool.

50. The bone graft profiler tool of claim 34, further comprising an alignment post internal recess which continues from the bone graft profiler tool internal recess, the alignment post internal recess being substantially cylindrical having symmetry around the axis of symmetry and being dimensioned suitably to accept a portion of an alignment post.

51. The bone graft profiler tool of claim 50, wherein the alignment post internal recess comprises an alignment post internal recess roof.

52. The bone graft profiler tool of claim 51, wherein the alignment post internal recess roof is in a radial plane.

53. The bone graft profiler tool of claim 51, wherein the alignment post internal recess roof is part of a cone.

54. The bone graft profiler tool of claim 51, wherein the alignment post internal recess roof can contact a top of an alignment post to limit an advancement distance of the bone graft profiler tool.

55. The bone graft profiler tool of claim 54, wherein the alignment post internal recess roof can contact a top of the alignment post without the roof of the bone graft profiler tool internal recess touching a top of the implant base.

56. The bone graft profiler tool of claim 50, wherein the bone graft profiler tool internal recess roof can contact a top of the implant base without the alignment post internal recess roof contacting a top of the alignment post.

57. The bone graft profiler tool of claim 50, wherein an alignment post clearance is defined as an alignment post internal recess inside diameter minus an outside diameter of a cylindrical portion of a distal region of the alignment post, and the alignment post clearance is less than 0.5 millimeters.

58. The bone graft profiler tool of claim 34, wherein an implant clearance is defined as a bone graft profiler tool internal recess inside diameter minus an implant base outside diameter, and an alignment post clearance is defined as an alignment post internal recess inside diameter minus an outside diameter of a cylindrical portion of a distal region of an alignment post, and the alignment post clearance is less than the implant clearance.

59. The bone graft profiler tool of claim 34, wherein an alignment post clearance is defined as an alignment post internal recess inside diameter minus an alignment post outside diameter, and the alignment post clearance is less than 0.5 millimeters.

60. The bone graft profiler tool of claim 50, further comprising a transition where the alignment post internal recess meets the bone graft profiler tool internal recess.

61. The bone graft profiler tool of claim 60, wherein the transition is a curved axisymmetric surface.

62. The bone graft profiler tool of claim 60, wherein the transition is a chamfer.

63. The bone graft profiler tool of claim 60, wherein the chamfer is suitable for guiding the bone graft profiler tool into engagement with an alignment post.

64. The bone graft profiler tool of claim 60, wherein an annular radial dimension of the bone graft profiler tool internal recess roof is less than a horizontal dimension of the alignment post chamfer.

65. The bone graft profiler tool of claim 62, wherein a bone graft profiler tool depth-to-end-of-chamfer is less than an alignment post height-to-chamfer.

66. The bone graft profiler tool of claim 34, wherein an alignment post height is greater than a depth of the alignment post internal recess.

67. The bone graft profiler tool of claim 34, wherein the bone graft profiler tool comprises a mark on its exterior surface.

68. The bone graft profiler tool of claim 67, wherein the bone graft profiler tool has a stop and wherein the mark is located at the same position along the axis of the bone graft profiler tool as a top of the implant base when the bone graft profiler tool stop is against its intended contact point.

69. The bone graft profiler tool of claim 67, wherein the bone graft profiler tool has a bone graft profiler tool internal recess roof and wherein the mark is located at the same distance along the axis of the bone graft profiler tool as the bone graft profiler tool internal recess roof.

70. The bone graft profiler tool of claim 34, wherein the bone graft profiler tool comprises passageways suitable to deliver liquid.

71. The bone graft profiler tool of claim 34, wherein the bone graft profiler tool has a hardness sufficient to cut bone.

72. The bone graft profiler tool of claim 34, wherein the bone graft profiler tool is made of corrosion-resistant metal.

73. An alignment post comprising an engagement region which is disposed to engage an implant base having an implant base outside diameter, and a distal region, extending outward from the engagement region, which is coaxial with the engagement region and, for at least a part of its length, is cylindrical.

74. The alignment post of claim 73, wherein the distal region is dimensioned suitably to cooperate with a bone graft profiler tool to either locate the bone graft profiler tool or align the bone graft profiler tool or both.

75. The alignment post of claim 73, wherein the distal region has a cylindrical portion having an outside diameter which is less than the implant base outside diameter.

76. The alignment post of claim 73, wherein the distal region has a cylindrical portion having an outside diameter which is substantially equal to the implant base outside diameter.

77. The alignment post of claim 73, wherein the engagement region comprises threads.

78. The alignment post of claim 73, further comprising, on the distal region at its end farthest away from the engagement region, a transition which is coaxial with the distal region.

79. The alignment post of claim 78, wherein the transition is a chamfer or a curved axisymmetric surface.

80. The alignment post of claim 73, further comprising, on the distal region at its end farthest away from the engagement region, a flat end.

81. The alignment post of claim 73 wherein the flat end is suitable to cooperate with a bone graft cutting tool to limit the advancement of the bone graft cutting tool along the axis of symmetry of the bone graft cutting tool.

82. The alignment post of claim 73, further comprising, in the distal region at its end farthest from the alignment region, an alignment post gripping feature suitable to engage an alignment post tool for rotating the alignment post.

83. The alignment post of claim 82, wherein the alignment post gripping feature is on the axis of the alignment post.

84. The alignment post of claim 82, wherein the alignment post gripping feature is a hexagonal recess or a spline recess or a hexagonal protrusion or a spline protrusion.

85. The alignment post of claim 73, further comprising, on the distal region at its end farthest away from the engagement region, a chamfer which is coaxial with the distal region.

86. The alignment post of claim 85, wherein the chamfer is suitable for guiding a bone graft profiler tool into engagement with the alignment post.

87. The alignment post of claim 86, wherein the bone graft profiler tool also comprises a chamfer.

88. The alignment post of claim 73, further comprising a shoulder suitable to abut against the implant base.

89. The alignment post of claim 88, wherein the shoulder is at a junction between the engagement region and the distal region.

90. The alignment post of claim 88, further comprising, at the shoulder, an undercut suitable to avoid interference with the implant base.

91. The alignment post of claim 73, wherein the alignment post is made of a biocompatible material.

92. The alignment post of claim 73, wherein the alignment post is sterile.

93. A bone graft suitable to fill a recess around an implant base, wherein the bone graft comprises rigid porous synthetic material.

94. The bone graft of claim 93, wherein the bone graft is pre-formed to a desired shape.

95. The bone graft of claim 93, wherein the bone graft comprises at least two separate pieces which together provide a desired shape.

96. The bone graft of claim 93, wherein the bone graft comprises a central hole.

97. The bone graft of claim 93, wherein the bone graft comprises a central hole having a bone graft inside diameter, and the implant base has an implant base greatest outside diameter, and the bone graft inside diameter is larger than the implant base greatest outside diameter by less than about 0.5 mm.

98. The bone graft of claim 93, wherein the bone graft is substantially axisymmetric.

99. The bone graft of claim 93, wherein the bone graft is non-axisymmetric.

330. The bone graft of claim 93, wherein the implant has external shape and dimensions which are chosen based on the shape and dimensions of a region of deteriorated or resorbed bone at a particular site in a particular patient.

101. The bone graft of claim 330, wherein the dimensions of the region of deteriorated or resorbed bone are determined radiographically.

102. The bone graft of claim 93, wherein the bone graft comprises a matrix of particles joined to each other forming a three-dimensionally interconnected network.

103. The bone graft of claim 102, wherein the matrix has pores wherein the distribution of pore volume as a function of pore size has a mode between 10 micrometers and 25 micrometers.

104. The bone graft of claim 102, wherein the matrix has a porosity between approximately 0.2 and approximately 0.6.

105. The bone graft of claim 93, wherein the bone graft comprises nonresorbable material.

106. The bone graft of claim 93, wherein the bone graft comprises hydroxyapatite.

107. The bone graft of claim 93, wherein the bone graft comprises resorbable material.

108. The bone graft of claim 93, wherein the bone graft comprises both nonresorbable and resorbable substances.

109. The bone graft of claim 93, further comprising channels which go into an interior.

310. The bone graft of claim 93, further comprising channels or patterns on a surface.

111. The bone graft of claim 93, wherein the bone graft comprises a surface having a surface geometry which is different from a geometry at an interior.

112. The bone graft of claim 93, wherein the bone graft comprises a surface having a surface composition which is different from a composition at an interior.

113. The bone graft of claim 93, wherein the bone graft comprises a surface having a surface geometry suitable to face natural bone.

114. The bone graft of claim 93, wherein the bone graft comprises a surface having a surface composition suitable to face natural bone.

115. The bone graft of claim 93, further comprising osteoconductive or osteoinductive substances.

116. The bone graft of claim 93, further comprising substances from a patient's own blood or other biological substances or demineralized bone matrix.

117. The bone graft of claim 93, further comprising a polymer.

118. The bone graft of claim 117, wherein the polymer is a comb polymer.

119. The bone graft of claim 117, wherein the polymer is resorbable.

120. The bone graft of claim 117, wherein the polymer is non-resorbable.

121. The bone graft of claim 93, wherein the bone graft is sterile.

122. The bone graft of claim 93, wherein the bone graft is manufactured at least in part by three dimensional printing.

123. A method of manufacturing a bone graft for filling a recess around an implant base, comprising spreading successive layers of a powder and three dimensionally printing an article to at least approximately the dimensions of the recess around the implant base.

124. The method of claim 123, wherein the powder comprises ceramic.

125. The method of claim 124, further comprising, after the three dimensional printing, heating the article sufficiently to partially sinter it.

126. The method of claim 123, wherein the powder comprises demineralized bone matrix.

127. The method of claim 123, further comprising, after all the described steps, introducing an additional substance into pores of the bone graft.

128. The method of claim 123, wherein the additional substance comprises substances from the patient's own blood or other biological substances.

129. An article manufactured by the method of claim 123.

130. A carrier having dimensions suitable to grip a bone graft which fills a recess around an implant base.

131. The carrier of claim 130, wherein the carrier comprises resilient material.

132. The carrier of claim 130, wherein the carrier comprises a spring or deformable member.

133. The carrier of claim 130, wherein the carrier is sterile.

134. A kit for installing a bone graft around an implant base, comprising:
at least one bone graft having bone graft dimensions, and at least one bone graft profiler tool having bone graft profiler tool dimensions.

135. The kit of claim 134, wherein at least one bone graft dimension is coordinated with dimensions of the implant base.

136. The kit of claim 134, wherein at least one bone graft dimension is coordinated with characteristics of a particular site in a particular patient.

137. The kit of claim 134, wherein at least one bone graft profiler tool dimension is coordinated with dimensions of the implant base.

138. The kit of claim 134, wherein at least one bone graft profiler tool dimension is coordinated with characteristics of a particular site in a particular patient.

139. The kit of claim 134, wherein at least one bone graft dimension is coordinated with a bone graft profiler tool dimension.

340. The kit of claim 134, wherein the bone graft comprises synthetic material.

141. The kit of claim 134, wherein the kit comprises a plurality of bone graft profiler tools intended to be used in a specified sequence.

142. The kit of claim 134, wherein the kit comprises a plurality of bone graft profiler tools intended to be used independently of each other.

143. The kit of claim 134, wherein the kit comprises at least one tool for performing localized cutting.

144. The kit of claim 134, further comprising an alignment post.

145. The kit of claim 144, further comprising an alignment post installation tool suitable for engaging the alignment post.

146. The kit of claim 134, further comprising at least one additional article selected from the group consisting of: a carrier for gripping the bone graft, templates, surgical screws, tools for installing surgical screws, formable filler material, antiseptics, antibiotics, a surgical membrane, and sutures.

147. The kit of claim 134, wherein at least some articles in the kit are sterile.

148. A bone graft shaped to fit around an implant base and having a bone graft external surface, and a bone graft profiler tool having a cutting envelope, wherein the bone graft external surface and the cutting envelope relate to each other by a defined mechanical interference that is everywhere constant to within a tolerance of less than 0.4 mm.
